(19) United States
(12) Patent Application Publication
(10) Pub. No.: US 2006/0282222 A1
(43) Pub. Date: Dec. 14, 2006

(54) Data analysis system and data analysis method

(76) Inventors: Satoshi Mitsuyama, Tokyo (JP); Kumiko Seto, Fuchu (JP); Takahiko Shintani, Tokyo (JP)

Correspondence Address: REED SMITH LLP, 3110 Fairview Park Drive, Suite 1400, Falls Church, VA, 22042, US

(21) Appl. No.: 11/212,696

(22) Filed: Aug. 29, 2005

(30) Foreign Application Priority Data
Jun. 13, 2005 (JP) 2005-171799

(51) Int. Cl. G06F 19/00

(52) U.S. Cl. 702/19; 702/22

(57) ABSTRACT

A data analysis apparatus has a first storage for storing information, a second storage for storing association between information, a unit for setting a condition to divide the information into a plurality of groups on the basis of association between the information stored in the second storage, a unit for setting an item to compare information divided into a plurality of groups, a unit for setting a condition to extract information to be compared, and an evaluation unit for extracting information that satisfies the condition for extracting information from the first storage, dividing information extracted on the basis of the condition for dividing the information into groups into a plurality of groups, and calculating evaluation values to conduct comparison as to a comparison item for each group.

### INCORPORATION BY REFERENCE

The present application claims priority from Japanese application JP 2005-171799 filed on Jun. 13, 2005, the content of which is hereby incorporated by reference into this application.

### BACKGROUND OF THE INVENTION

The present invention relates to an apparatus, and method, for analyzing and displaying association between information stored in a database.

In clinical practice, implementation of medicine based on scientific evidence (EBM: Evidence Based Medicine) has become a problem with a view to improving the quality of medical care. For implementing the EBM, objective information that becomes evidence is needed. For obtaining evidence having the highest quality, a clinical trial performed under a suitable study design is needed. In a clinical trial performed in a large scale via various procedures for maintaining the objectivity, enormous funds and time are needed.

In recent years, medical information systems for electronically managing medical data, represented by electronic medical record have spread. Information generated in daily medical examination is being stored as electronic data. It is anticipated that diagnostic decision supporting information which should become evidence can be extracted by analyzing association between data if a database that stores a large amount of such information is constructed.

As for the conventional system, and method, for analyzing clinical data obtained during daily medical examination, for example, JP-A-2004-185547, entitled “Medical data analysis system and medical data analyzing method” is known. When patients are divided into a plurality of groups and a component ratio of each group for all data is examined, the operator only specifies n items to use for group division. In response to this, 2ⁿ groups including combinations of those items are automatically generated and the component ratio is calculated in this system and method. Furthermore, rules including a noted item are searched for and retrieved by using an association rule obtained as a result of data mining, and items included in antecedents and consequents of those rules are automatically set as items for analysis.

As a system for utilizing the association rule obtained as a result of the data mining and exhibiting diagnostic decision supporting information, for example, “Knowledge retrieval method in decision support system for genetic diagnosis,” Kumiko Seto et al., 2004 National Conventional Record of the Institute of Electronics, Information and Communication Engineers, P. 76 is known. In this method, only rules in which uncontrollable items (items that cannot be changed by therapy or improvement in the lifestyle habit) do not correspond with the current patient state are excluded from among association rules, and rules are classified into “rules useful for risk forecasting such as an affection or a relapse” and “rules useful for prognosis improvement or prophylaxis” and exhibited.

In JP-A-2003-310557, entitled “medical support apparatus, medical support method, and medical support program,” a decision tree for making a diagnostic decision on each disease is created by means of the decision tree analysis on the basis of previously stored case data and recorded in a knowledge base. When patient data is input, probabilities of respective diseases are found according to the decision tree, and the diseases are extracted and displayed as candidate diseases. Alterable items and unalterable items are discriminated. As regards the alterable items, candidate diseases at the time when the items are spuriously altered are extracted and presented.

### SUMMARY OF THE INVENTION

According to the method disclosed in JP-A-2004-185547, condition setting for analyzing clinical data can be made efficient. When it is desirable to obtain useful information concerning a specific patient and consequently it is desirable to know items required for obtaining information that is the most important to make a decision, however, it is necessary to select items entirely in dependence upon experience or combine various items by trial and error. When relying upon the experience, there is a fear of overlooking information that has not been obtained by experience gained until then. When relying upon trial and error, combinations of items become enormous, and it is difficult to obtain optimum information in a practical time during medical examination. This is a first problem.

Furthermore, according to the method disclosed in JP-A-2004-185547, it is possible to automatically set only conditions that are significant as regards data to refer to, by utilizing the association rules. In this method, however, a certain rule is selected from among association rules, and association among items included in it is referred to. This results in a second problem that it is not possible to compare and study a plurality of rules at a time. For example, if there are two rules concerning effects of a certain drug A and a different drug B, it is necessary to first perform data analysis using a rule concerning the drug A, then perform data analysis using a rule concerning the drug B, and then compare and study both results. If there a large number of drugs that become candidates for selection, therefore, it is necessary to perform analysis many times.

According to the method disclosed in the aforementioned document, “Knowledge retrieval method in decision support system for genetic diagnosis,” it is possible to grasp the state which completely corresponds with the antecedents, i.e., the forecasted state at the time when the condition of disease will be improved by therapy, by retrieving rules associated with a specific patient and displaying a list of the rules. However, there is a third problem that it is not possible to obtain information, such as improvement expected as compared with the current situation of the patient, and an item improvement of which brings about the greatest effect when there are a plurality of items to improve.

According to the method disclosed in JP-A-2003-310557, candidate diseases can be extracted and displayed on the basis of the state of the patient. As regards the alterable items, candidate diseases at the time when the items are spuriously altered are extracted and displayed. In the present method, however, a decision tree is used to make a decision. Even if data in a front end portion (portion near the leaf) of the decision tree are obtained, these data cannot be used for decision provided that data in the middle of the decision tree (data in a portion near the stem) is not obtained. This is a fourth problem.

The first problem can be solved by providing a first storage for storing information such as clinical data, a second storage for storing association between information stored in the first storage in a form such as association rules, a grouping item setting unit for setting a condition to classify the information into a plurality of groups based on the association between information stored in the second storage, a comparison item setting unit for setting an item to conduct comparison as to information classified into a plurality of groups based on the association between information stored in the second storage, and a search condition setting unit for setting a condition to search for information to compare. In other words, it is made possible to previously set only items that exert influence upon analysis results in a comparison item, a search condition, and a grouping item by using association between information stored in the second storage. As a result, the operator can set conditions for analysis rapidly and precisely.

The second, third and fourth problems can be solved by providing besides the above-described configuration an evaluation unit for retrieving information that satisfies the search condition from the first storage, classifying information extracted on the basis of the condition for dividing into a plurality of groups, and calculating evaluation values for conducting comparison as to the comparison item of each group. In other words, it is possible to simultaneously set conditions respectively for a plurality of items used in a plurality of rules, perform analysis, and compare results. As a result, the second problem can be solved. Furthermore, the rule conditions are not used as they are, but the comparison item, the search condition, and the grouping item can be set. Therefore, changes in analysis results obtained at the time when various conditions are combined can be observed. Thus, the third problem can be solved. Furthermore, the evaluation unit calculates evaluation values by using all conditions that are set. As a result, the fourth problem can be solved.

Items that exert influence upon analysis results are automatically extracted and presented as choices for the analysis condition. As a result, the operator can obtain precise analysis results rapidly with simple operation. Furthermore, the analysis condition is set and altered, and the evaluation values are recalculated. If a value in a certain item is altered, therefore, influence exerted upon other items can be simulated.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a configuration of a first embodiment according to the present invention;

FIG. 2 is a diagram showing a configuration of an item definition table;

FIG. 3 is a diagram showing configurations of tables storing association rules;

FIG. 4 is a diagram showing a processing flow of the first embodiment according to the present invention;

FIG. 5 is a diagram showing a configuration of a condition storage variable;

FIG. 6 is a diagram showing a processing flow for retrieving and extracting rules associated with clinical information;

FIG. 7 is a diagram showing a configuration of an analysis view in the first embodiment according to the present invention;

FIG. 8 is a diagram showing a processing flow for setting a comparison item;

FIG. 9 is a diagram showing a processing flow for setting a grouping item;

FIG. 10 is a diagram showing a processing flow for setting evaluation rules;

FIG. 11 is a diagram showing a processing flow for calculating an evaluation value;

FIG. 12 is a diagram showing an analysis result example in the first embodiment according to the present invention;

FIG. 13 is a diagram showing an analysis result example in the first embodiment according to the present invention;

FIG. 14 is a diagram showing an analysis result example in the first embodiment according to the present invention;

FIG. 15 is a diagram showing an analysis result example in the first embodiment according to the present invention;

FIG. 16 is a diagram showing a configuration of a second embodiment according to the present invention;

FIG. 17 is a diagram showing a configuration of an analysis view in the second embodiment according to the present invention;

FIG. 18 is a diagram showing a processing flow of the second embodiment according to the present invention;

FIG. 19 is a diagram showing a processing flow for selecting a patient;

FIGS. 20A and 20B are diagrams each showing a patient selection view example;

FIG. 21 is a diagram showing a processing flow for setting choices in a major category setting pull-down menu for comparison item setting; and

FIG. 22 is a diagram showing a processing flow for setting choices in a major category setting pull-down menu for grouping item setting.

### DESCRIPTION OF THE EMBODIMENTS

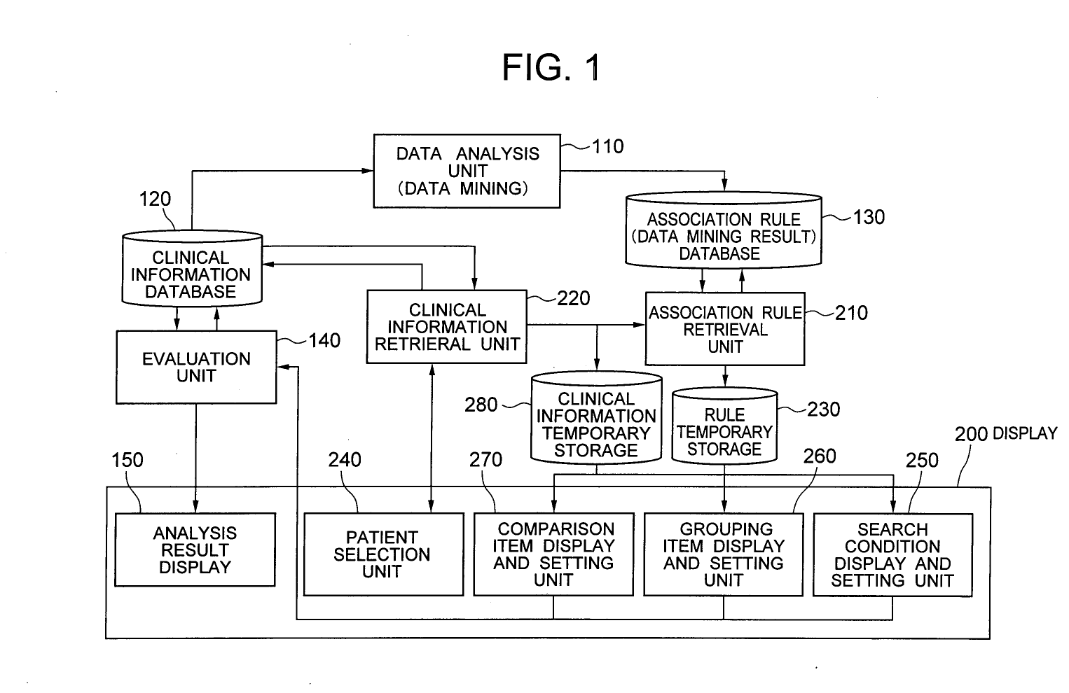

A configuration example of a clinical data analysis system according to the present invention is shown in FIG. 1. A clinical information database 120 stores and manages information, such as the gender, age, disease name, therapy method, prescription, condition of disease, and results of laboratory tests, generated during daily medical examination. This database may share a database, such as an electronic medical record database or an order entry system database, included in a hospital information system. A data import unit which is not illustrated may be provided to import data from the system. A data input unit which is not illustrated may be provided to allow a doctor or nurse to directly input data.

A data analysis unit 110 analyzes association between clinical information by utilizing data stored in a clinical information database 120, and outputs a result of the analysis in an association rule form. For the analysis, for example, a technique called association rule mining is used. In this technique, combinations of simultaneously occurring values are counted from among a series of data, and combinations of often simultaneously occurring values are output in the form of association rules. The association rules are rules described in the “IF THEN” form. A condition corresponding to “IF” is called antecedent, and a condition corresponding to “THEN” is called consequent. Each of the antecedent and the consequent takes a form obtained by joining a plurality of conditions “item name=value” with “AND”s. As the association rule, for example, the following rule is output.

IF (prescription=drug A) AND (gender=M) AND (disease=hypertension) THEN (systolic blood pressure <=140)

This rule represents that “if a drug A is prescribed for a patient who is male in gender and who has illness diagnosed as hypertension, then the patient tends to be 140 or less in systolic blood pressure.”

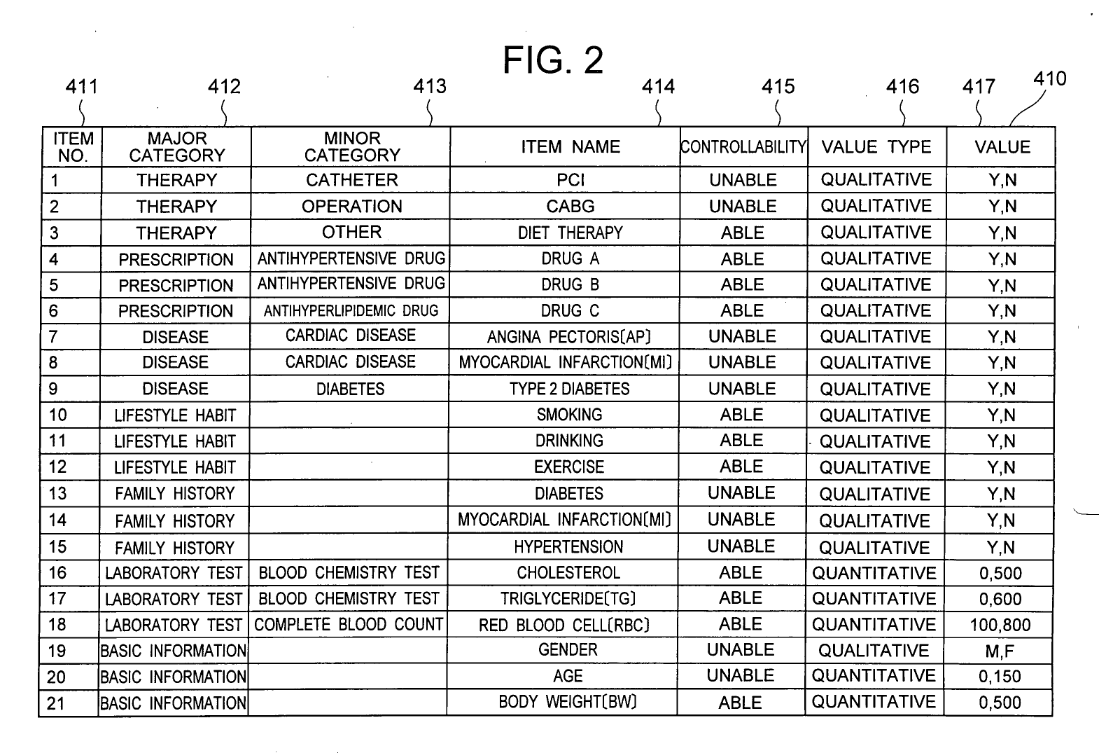

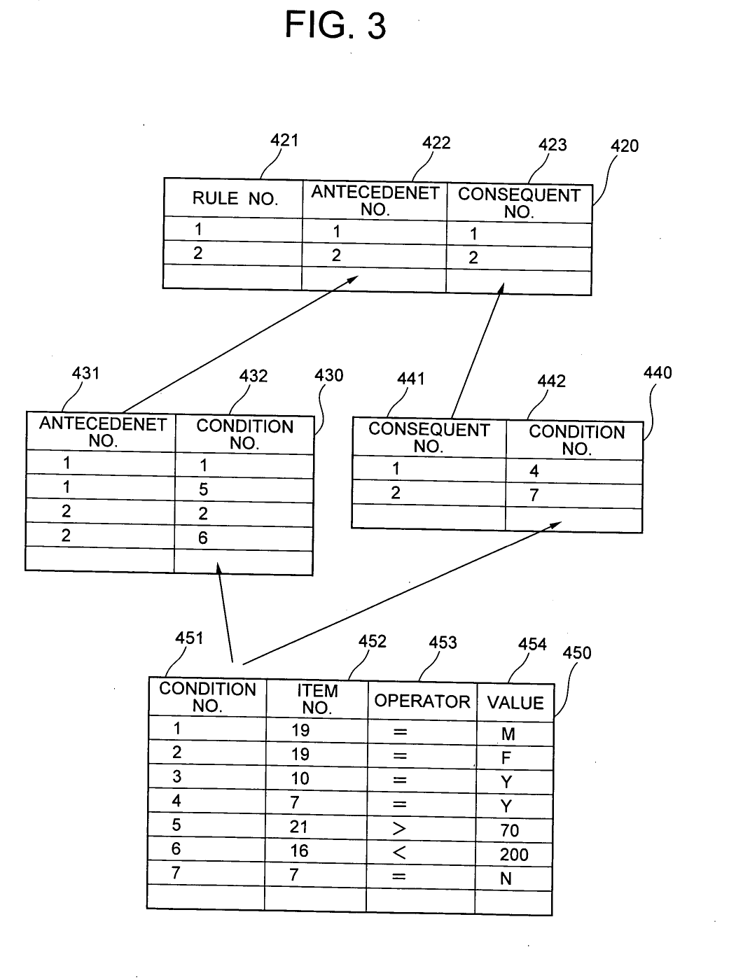

An association rule database 130 stores association rules output by the data analysis unit 110. Furthermore, although not illustrated, an association input unit may be separately provided to allow a doctor or nurse to transform knowledge obtained from a paper or the like into the association rule form and input it directly to the association rule database 130. Structures of tables included in the association rule database 130 will now be described in detail with reference to FIGS. 2 and 3.

FIG. 2 shows a configuration of an item definition table 410. This table defines kinds, attributes and so on of items used for definition of rules, among data items included in the clinical information database 120. The item definition table 410 includes an item no. field 411, a major category field 412, a minor category field 413, an item name field 414, a controllability field 415, a value type field 416 and a value field 417. A no. (item no.) serving as key information for uniquely specifying an item is stored in the item no. field 411. For each of items, its major category and minor category are determined according to its kind and purpose, and the major category and minor category are stored in the major category field 412 and the minor category field 413, respectively. An item name is stored in the item name field 414. The controllability field 415 stores information indicating whether the value of the item can be altered by therapy or improvement of the lifestyle habit. For example, since lifestyle habit in item nos. 10 to 12 can be changed by an effort of the patient himself or herself, “able” which indicates that the item can be altered is stored in the controllability field 415. Since the gender in the item no. 19 and the age in the item no. 20 are items that cannot be changed by therapy or the effort of the patient himself or herself, “unable” which indicates that the item cannot be altered is stored in the controllability field 415. A type indicating whether a value stored for the item is quantitative data or qualitative data is registered in the value type field 416. A value that can be assumed by the item is stored in the value field 417. If the item is qualitative data, discrete values that can be assumed by the item are stored in the value field 417. If the item is quantitative data, a range of the value that can be assumed by the item are stored in the value field 417.

FIG. 3 is a diagram showing configurations of tables that store association rules. Each of the association rules assumes the form “IF A THEN B” as described earlier. Each of A and B is a condition statement having a form that is obtained by joining a plurality of condition expressions each having a form “item comparison operator value” with “AND”s. The “item” is an item of clinical data, and “value” is a value that can be assumed by the item. The “comparison operator” is the equality sign (=), an inequality sign (<, >) or the like. For example, each of A and B has a form such as “gender=M AND age>60 AND disease myocardial infarction [Mi].

A condition expression table 450 is a table for storing condition expressions each of which has a form “item comparison operator value.” This table includes a condition no. field 451, an item no. field 452, an operator field 453, and a value field 454. A no. (condition no.) serving as key information for uniquely specifying each condition expression is stored in the condition no. field 451. The item no. field 452 stores an item no. corresponding to an item on the left side of the condition expression. As the item no., a value defined in the item definition table 410 shown in FIG. 2 is used. A comparison operator such as the equality sign or inequality sign is stored in the operator field 453. A value corresponding to the right side of the condition expression is stored in the value field 454.

An antecedent table 430 is a table storing condition statements in IF clauses of association rules. The antecedent table 430 includes an antecedent no. field 431 and a condition no. field 432. The antecedent is formed by combining a plurality of condition expressions each defined by one record in the condition expression table 450, with “AND”s. One condition expression for forming the antecedent is stored in each record in the antecedent table 430. An antecedent no. field 431 stores a no. (antecedent no.) for uniquely specifying an antecedent. Since each antecedent is typically represented by joining a plurality of condition expression, the same antecedent no. is stored in records that constitute the same antecedent. A condition no. for specifying a condition expression defined in the condition expression table 450 is stored in the condition no. field. In the antecedent table 430 shown in FIG. 3, two condition nos. 1 and 5 are stored for the antecedent no. 1. With reference to the condition expression table 450, it will be appreciated that the item no., operator, and value corresponding to condition no. 1 are “19,” “=,” and “male,” respectively. With reference to the item definition table 410, the item name corresponding to the item no. 19 is “gender.” Therefore, a condition expression corresponding to the condition no. 1 becomes “gender=male.” As for the condition no. 5, the item no., operator, and value are respectively “21,” “>,” and “70,” with reference to the condition expression table 450. Since the item name corresponding to item no. 21 is “body weight” in the condition expression table 450, a condition expression corresponding to the condition no. 5 becomes “body weight>70.” A condition statement corresponding to the antecedent no. 1 in the antecedent table 430 becomes a condition statement obtained by joining the condition expressions corresponding to the condition no. 1 and the condition no. 5 in the condition expression table 450 with “AND”. Finally, therefore, a condition statement “gender=male AND body weight>70” is obtained.

A consequent table 440 is a table for storing condition statements in THEN clauses of association rules. The consequent table 440 has a structure similar to that of the antecedent table 430. A consequent no. field 441 stores a no. (consequent no.) for uniquely specifying a consequent, and the consequent no. field 441 corresponds to the antecedent no. field 431 in the antecedent table 430. A condition no. field 442 performs the same role as the condition no. field 432 in the antecedent table 430 does. In the consequent table 440 shown in FIG. 3, a condition no. 4 is stored for a consequent no. 1. With reference to the condition expression table 450, it will be appreciated that the item no., operator, and value corresponding to condition no. 4 are “7,” “=,” and “Y,” respectively. With reference to the item definition table 410, the item name corresponding to the item no. 7 is “angina pectoris [AP].” Therefore, a condition expression corresponding to the item no. 4 becomes “angina pectoris [AP]=Y.”

Since the consequent no. 1 includes only the condition no. 4, this condition expression as it is becomes the condition statement corresponding to the consequent no. 1.

An association rule definition table 420 is a table for storing an antecedent and a consequent to constitute association rules. The association rule definition table 420 includes a rule no. field 421, an antecedent no. field 422 and a consequent no. field 423. Each record represents one association rule, and stores information that specifies condition statements to use from among condition statements defined in the antecedent table 430 and the consequent table 440. A rule no. field 421 stores a no. (rule no.) serving as key information for uniquely specifying an association rule. An antecedent no. for specifying an antecedent to constitute a specific rule from among a plurality of antecedents defined in the antecedent table 430 is stored in the antecedent no. field 422. In the same way, a consequent no. is stored in the consequent no. field 423. In the association rule definition table 420 shown in FIG. 3, the antecedent no. 1 and consequent no. 1 are stored for the rule no. 1. As described above, the condition statement corresponding to the antecedent no. 1 stored in the antecedent table 430 is “gender=male AND body weight>70.” The condition statement corresponding to the consequent no. 1 stored in the consequent table 440 is “angina pectoris [AP]=Y.” Therefore, it will be appreciated that a rule corresponding to the rule no. 1 is “IF gender=male AND body weight>70 THEN angina pectoris [AP]=Y.”

A display 200 shown in FIG. 1 is used by an operator to conduct condition setting for analyzing data in the clinical information database and display an analysis result. The operator sets conditions for analysis using a patient selection unit 240, a search condition display and setting unit 250, a grouping item display and setting unit 260, and a comparison item display and setting unit 270 via the display 200. The patient selection unit 240, the search condition display and setting unit 250, the grouping item display and setting unit 260, and the comparison item display and setting unit 270 generate retrieval conditions for data analysis in cooperation with an association rule retrieval unit 210, a clinical information retrieval unit 220, a rule temporary storage unit 230 and a clinical information temporary storage unit 280. The generated retrieval conditions are delivered to an evaluation unit 140. The evaluation unit 140 extracts data that corresponds with the conditions from the clinical information database 120, and calculates an evaluation value. The evaluation value is a numerical value that becomes an index for judging clinical usefulness of the extracted data. In the case of quantitative data, the evaluation value is an average. In the case of qualitative data, a component ratio of a value that can be assumed in a group satisfying certain conditions is calculated. The evaluation value calculated by the evaluation unit 140 is delivered to an analysis result display 150. The analysis result display 150 displays the evaluation value graphically on the display 200.

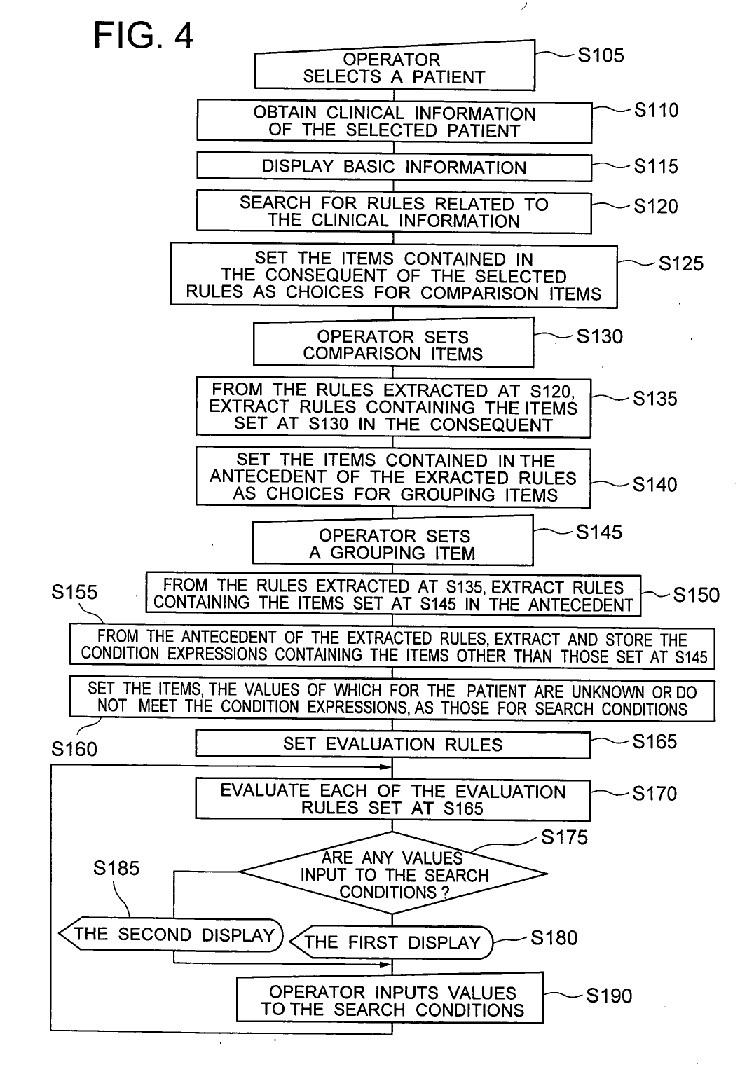

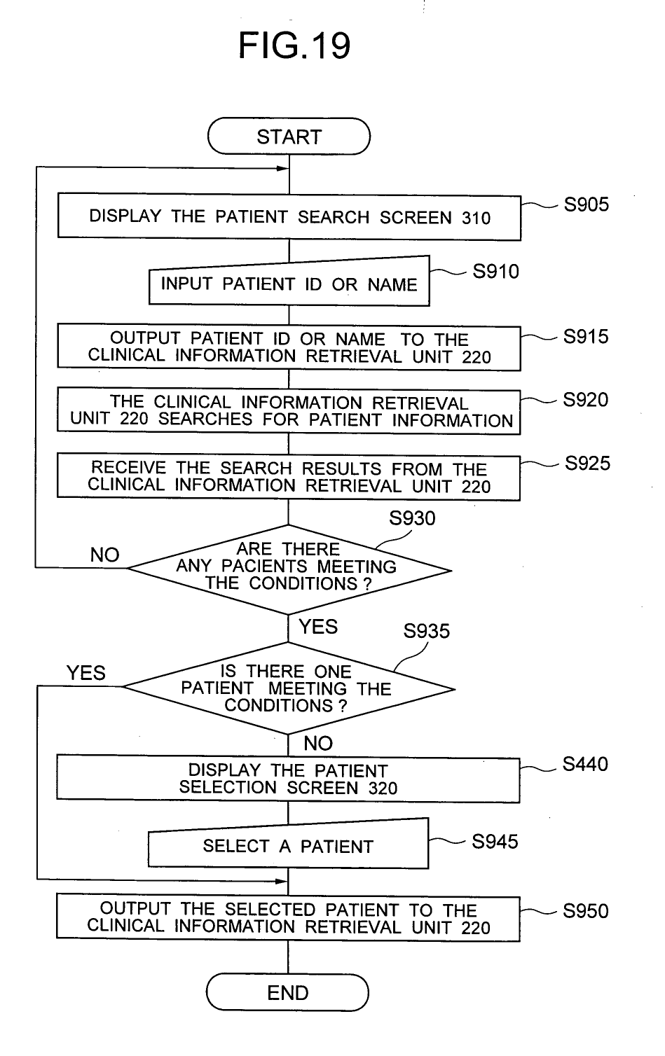

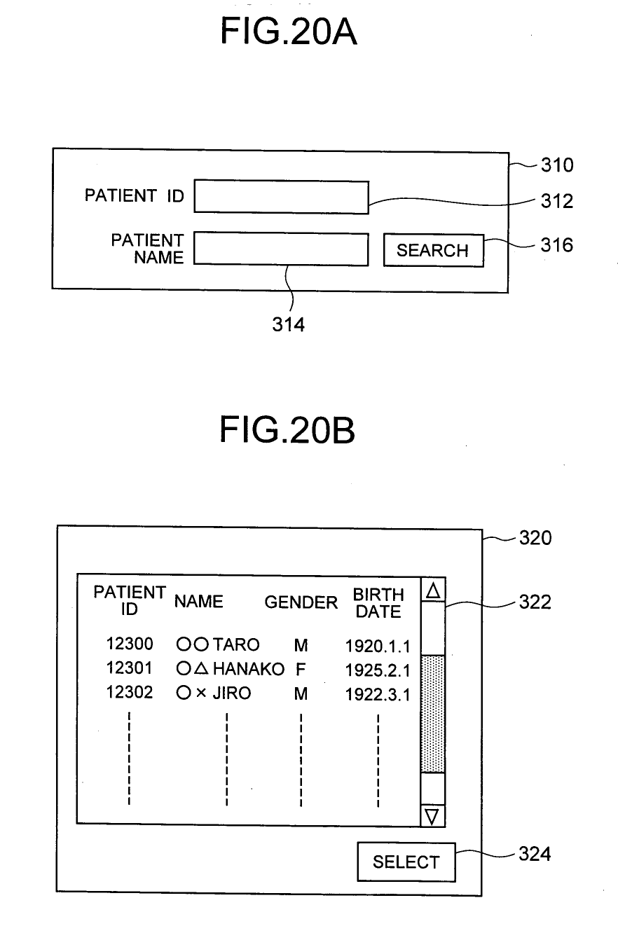

Operation of the present system will be described in detail with reference to FIG. 4. In the present system, the operator first specifies one specific patient using the patient selection unit 240 (step S105). A concrete operation conducted by the operator at the step S105 and detailed contents of processing conducted in the patient selection unit 240 will now be described with reference to FIGS. 19, 20A and 20B. FIG. 19 is a diagram showing processing conducted to control a patient selection view by the patient selection unit 240 and processing conducted to specify a patient by the operator. Each of FIGS. 20A and 20B shows an example of a view displayed on the display 200 by the patient selection unit 240.

First, the patient selection unit 240 displays a patient search screen 310 shown in FIG. 20A (step S905). The patient search screen 310 is a screen used to input information for searching for a patient. The information for searching for a patient is, for example, a patient ID or a patient name. In the example shown in FIG. 20, a patient ID input area 312 and a patient name input area 314 are provided in the patient search screen 310. The operator inputs a part or the whole of a patient ID to the patient ID input area 312, or inputs a part or the whole of a patient name to the patient name input area 314, and clicks a search button 316 (step S910). The input information is delivered to the clinical information retrieval unit 220 (step S915). The clinical information retrieval unit 220 issues an SQL for searching for a patient that corresponds with the input patient ID or patient name to the clinical information database 120 and executes a search (step S920). The patient selection unit 240 receives a result of the search (step S925), and checks whether there is a patient that corresponds with the conditions (step S930). If there is not any patient that corresponds with the conditions, the patient selection unit 240 returns processing to the step S905, and displays the patient search screen 310 again. If there is a patient that corresponds with the conditions, the patient selection unit 240 further checks the number of patients that correspond with the conditions (step S935). Typically, there is one patient that corresponds with the conditions. If the operator inputs only a part of the name or patient ID or there are patients of the same family and personal name, there is a possibility that a plurality of patients meeting the conditions. If there is one patient meeting the conditions, the processing proceeds to step S950 and information (key information in the database) that uniquely specifies the patient is delivered to the clinical information retrieval unit 220.

If there are a plurality of patients meeting the conditions at the step S935, a patient selection screen 320 shown in FIG. 20B is displayed on the display 200 (step S940). The patient selection screen 320 includes a patient selection area 322 and a select button 324. Information of a plurality of patients meeting the conditions are displayed in the patient selection area 322 in a list form. Information required for the operator to narrow down to one aimed patient is displayed. For example, a patient ID, a family and personal name, a gender, and a birth date are displayed. If the operator selects one patient from among them with a mouse or keyboard operation and clicks the select button (step S945), information (key information in the database) for uniquely specifying the selected patient is delivered to the clinical information retrieval unit 220 (step S950). If the processing heretofore described is finished, the processing proceeds to step S110 shown in FIG. 4. The clinical information retrieval unit 220 searches the clinical information database 120 for clinical information of the selected patient, and extracts the clinical information of the selected patient. The extracted clinical information is stored in the clinical information temporary storage unit 280.

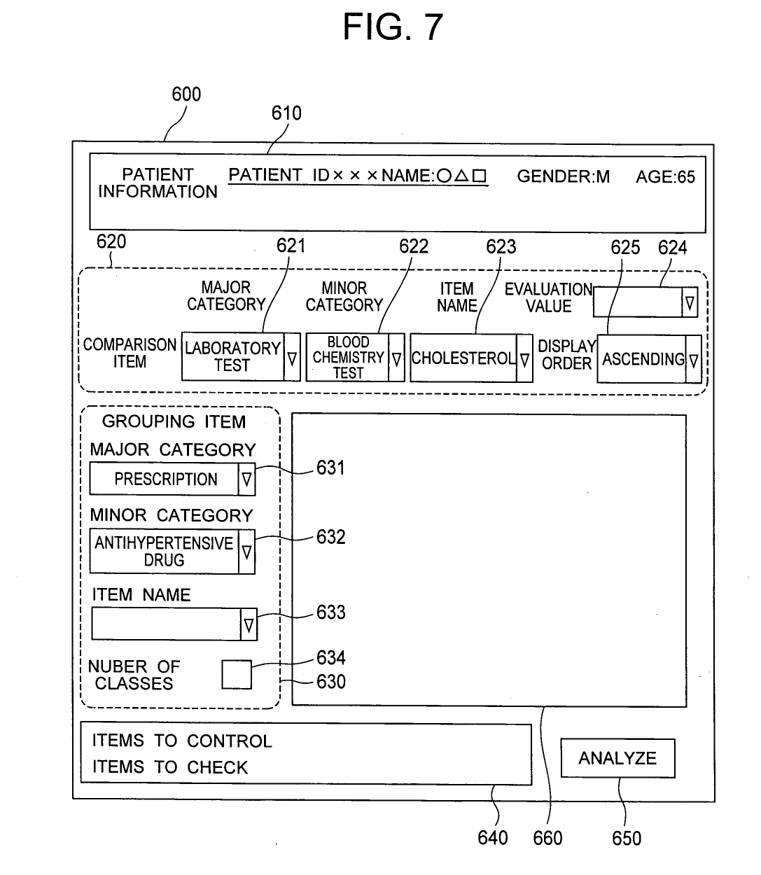

Subsequently, processing at step S115 shown in FIG. 4 is executed. In this processing, the clinical information retrieval unit 220 displays the retrieved basic information of the patient on an analysis screen. The analysis screen is displayed on the display 200. An example of the analysis screen is shown in FIG. 7. The analysis screen 600 includes a patient information display area 610, a comparison item setting area 620, a grouping item setting area 630, a search condition setting area 640, an “analyze” button 650, and an analysis result display area 660. The comparison item setting area 620 includes a major category setting pull-down menu 621, a minor category setting pull-down menu 622, an item name setting pull-down menu 623, an evaluation value setting pull-down menu 624, and a display order setting pull-down menu 625. The grouping item setting area 630 includes a major category setting pull-down menu 631, a minor category setting pull-down menu 632, an item name setting pull-down menu 633 and a number of classes setting text box 634. At the step S115, basic information included in clinical information of the patient obtained by the clinical information retrieval unit 220 at the step S110 is displayed in the patient information display area 610. In the example shown in FIG. 7, the patient ID, family and personal name, gender and age are displayed. However, display items are not restricted to these items. As occasion demands, the items may be added or deleted.

Subsequently, the association rule retrieval unit 210 searches the association rule database 130 for rules related to clinical information of the selected patient on the basis of contents in the clinical information temporary storage 280, and stores a result of the search in the rule temporary storage 230 (step S120). In order to search for rules related to the clinical information of the patient, the association rule retrieval unit 210 first checks whether each of conditions stored in the condition expression table 450 in the association rule database 130 corresponds with the clinical information of the patient, and classifies the conditions into the following four kinds.

(a) Conditions that correspond with the clinical information of the patient

(b) Conditions for which there is no clinical information of the patient

(c) Conditions that do not correspond with the clinical information of the patient and that are controllable

(d) Conditions that do not correspond with the clinical information of the patient and that are uncontrollable

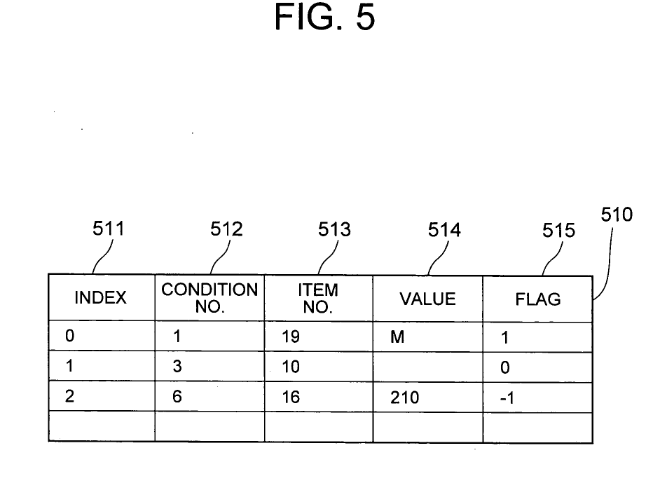

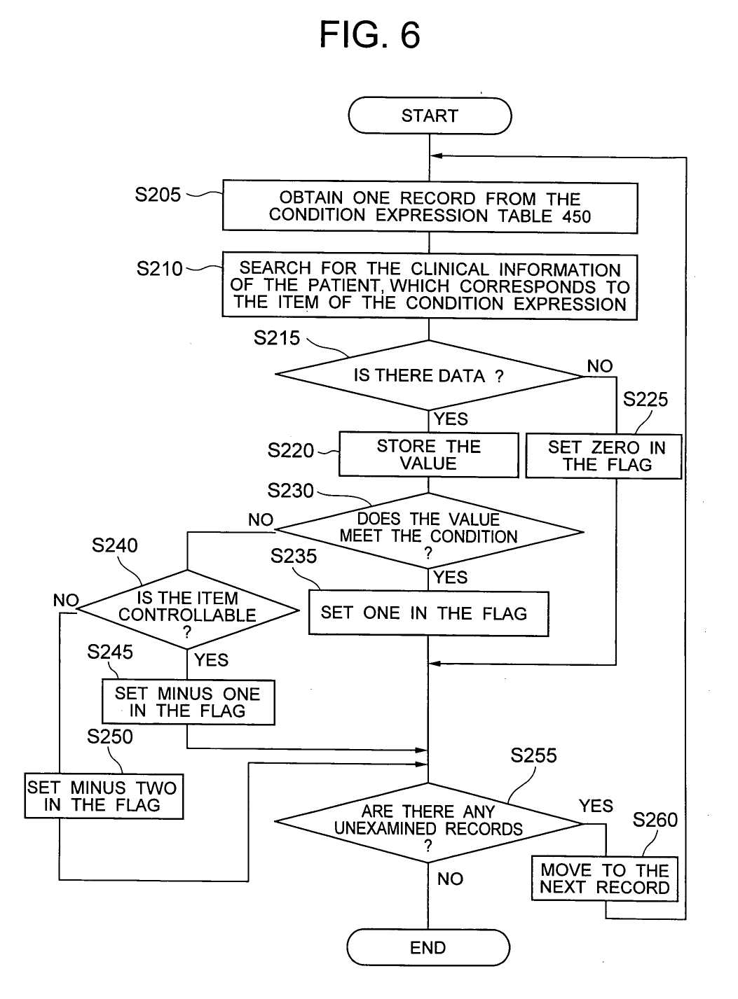

Specifically, classification into the four kinds is conducted according to a processing flow shown in FIG. 6 by using a condition storing variable 510 in the rule temporary storage 230 shown in FIG. 5. The condition storing variable 510 is an array including a condition no. field 512, an item no. field 513, a value field 514 and a flag field 515. Each record is identified by an index 511.

First, one record is obtained from the condition expression table 450 in the association rule database 130 (step S205). The condition no. and item no. contained in the record extracted at this time are stored in the condition no. field 512 and the item no. field 513 of the condition storing variable 510. Subsequently, as regards the data item contained in the condition expression, data of the currently selected patient is searched for (step S210). On the basis of the result of the search, it is determined whether there is pertinent data (step S215). If there isn't pertinent data, “0” is set in the flag field 515 in the condition storing variable 510 (step S225), and then processing proceeds to step S255. If there is pertinent data, its value is stored in the value field 514 in the condition storing variable 510 (step S220). Thereafter, it is determined whether the obtained value corresponds with the condition expression obtained at the step S205 (step S230). If the value corresponds with the condition, then “1” is set in the flag field 515 (step S235), and the processing proceeds to the step S255. If the value does not correspond with the condition, it is determined whether the item is controllable by referring to information in the controllability field 415 in the item definition table 410 shown in FIG. 2 (step S240). If the item is controllable, “−1” is set in the flag field (step S245). If the item is not controllable, “−2” is set in the flag field (step S250). Subsequently, it is determined whether there are unexamined records in the condition expression table 450 (step S255). If there is an unexamined record, movement to the next record is conducted (step S260) and the processing at the step S205 and subsequent steps is repeated. At this time, the next record is used in the condition storing variable 510 as well. If there are not unexamined records, the processing is finished. Owing to the processing heretofore described, “1,” “0,” “−1” and 2” are stored in flag fields 515 of conditions corresponding to (a), (b), (c) and (d), respectively.

Search for excluding rules that contain “uncontrollable conditions that do not correspond with the patient information” corresponding to (d) in the antecedent is conducted, and rules are extracted. This processing can be executed easily by excluding rules that contain a condition expression having a value of −2 in the flag field 515, in the antecedent. Owing to the processing, only rules in which the condition in the antecedent is completely met or there is a possibility that condition in the antecedent will be met are extracted. “There is a possibility that condition in the antecedent will be met” means “a condition expression in which the patient data is unknown is contained” or “a condition expression that does not correspond with the patient data, but that has a possibility of corresponding with the patient data (that can be controlled) as a result of therapy is contained.” The extracted rules are stored in the rule temporary storage 230 as data having a data structure similar to the data structure shown in FIG. 3.

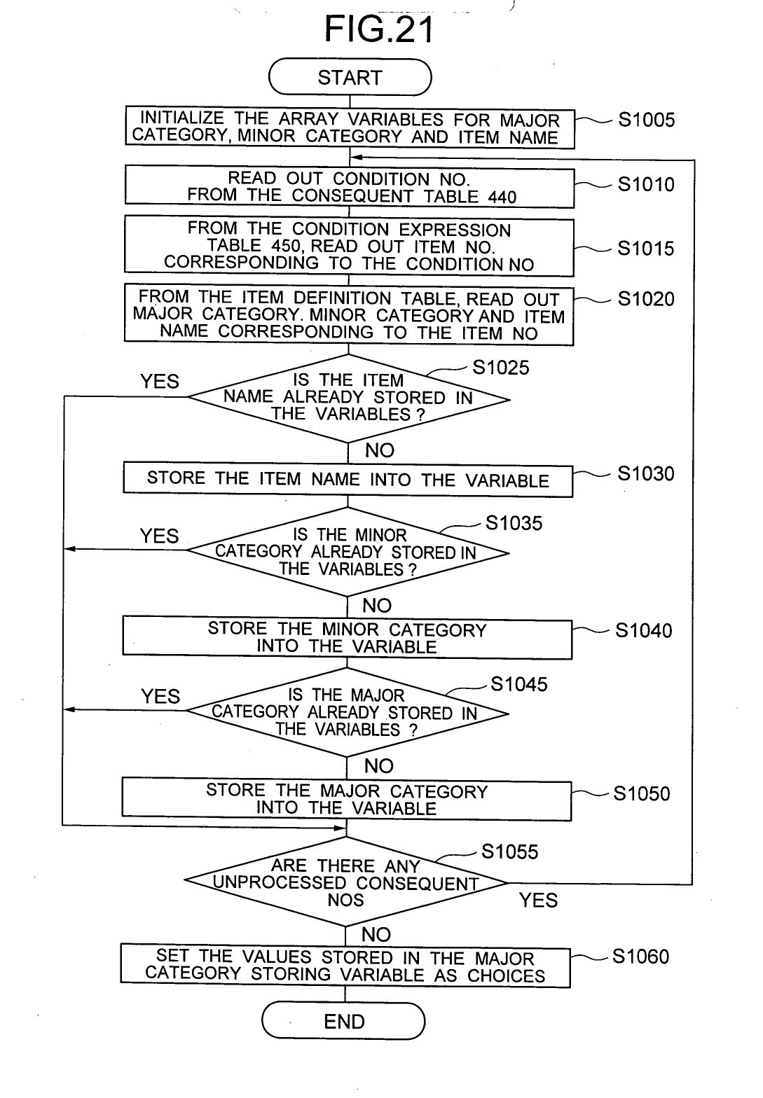

The processing shown in FIG. 6 is thus finished, and subsequently processing at step S125 is executed. In this processing, the comparison item display and setting unit 270 sets major categories of items contained in condition expressions that form consequents of rules stored in the rule temporary storage 230, as choices in the major category setting pull-down menu 621 for comparison item setting in the analysis screen 600. Its concrete processing will now be described with reference to FIG. 21. First, the comparison item display and setting unit 270 initializes the major category storing array variables, minor category storing array variables, and item name storing array variables for comparison item setting (step S1005), and then reads out one of condition nos. stored in the consequent table 440 in the rule temporary storage 230 (step S1010). For example, 4 and 7 are stored in the consequent table 440 as condition nos. One of them, for example, no. 4 is read out at step S1010. An item no. corresponding to this condition no. is read out from the condition expression table 450 (step S1015). Furthermore, a major category, a minor category and an item name corresponding to the item no. are read out from the item definition table 410 (step S1020). In the above-described example, the condition no. is 4. At the step S1015, therefore, a field having 4 as the condition no. in the condition expression table 450 is referred to, and an item no. 7 is obtained. Furthermore, at the step S1020, a field having 7 as the item no. in the item definition table 410 is referred to, and “disease,” “cardiac disease,” and “angina pectoris” are obtained as the major category, minor category and item name.

It is determined whether the item name read out is already stored in the item name storing array variables. If the item name is already stored, the processing proceeds to step S1055 (step S1025). Otherwise, the item name read out is newly stored in the item name storing array variable (step S1030). Subsequently, it is determined whether the minor category read out is already stored in the minor category storing array variables. If the minor category is already stored, the processing proceeds to the step S1055 (step S1035). Otherwise, the minor category read out is newly stored in the minor category storing array variable (step S1040). In addition, it is determined whether the major category read out is already stored in the major category storing array variables. If the major category is already stored, the processing proceeds to the step S1055 (step S1045). Otherwise, the major category read out is newly stored in the major category storing array variable (step S1050). It is determined whether there is an unprocessed consequent no. If there are unprocessed consequent nos., the processing at the step S1010 and the subsequent steps are repeated with respect to those consequent nos. (step S1055). Finally, the major categories thus stored in the major category storing variables are set as choices in the major category setting pull-down menu 621 for comparison item setting (step S1060). Each minor category is a name of a high-rank group obtained by grouping item names every kind. Each major category is a name of a high-rank group obtained by further grouping minor categories. These are predetermined so as to facilitate condition setting for analysis, and stored in the item definition table 410. In the example of the item definition table 410 shown in FIG. 2, two minor categories “anti-hypertensive drug” and “antihyperlipemic drug” are defined for the major category “prescription.” In addition, the “anti-hypertensive drug” contains two item names, “drug A” and “drug B.” The “anti-hyperlipidemic drug” contains an item name, “drug C.”

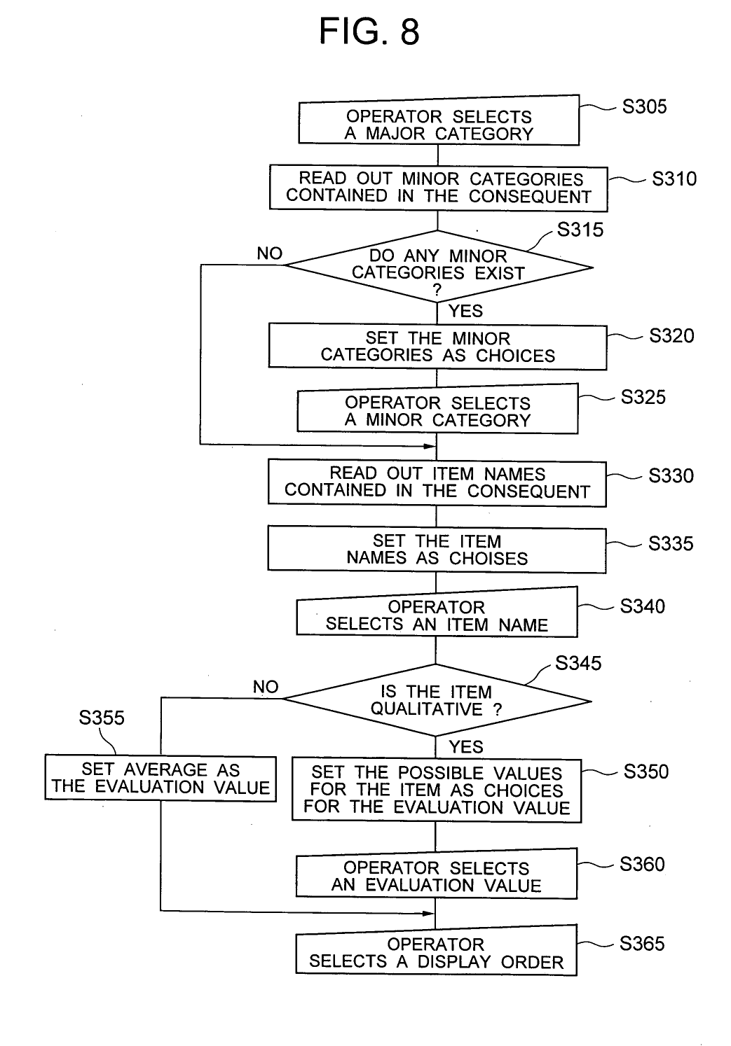

Thus, the processing shown in FIG. 21 is finished. Subsequently, processing at step S130 shown in FIG. 4 is executed. At the step S130, the operator sets details of items to compare, using the comparison item setting area 620 in the analysis screen 600. A detailed flow of operation conducted by the operator at the step S130 and a screen control method is shown in FIG. 8. Processing other than the operation conducted by the operator in the present flow diagram is conducted by the comparison item display and setting unit 270. The operator first selects a major category of an item to set, from choices in the major category setting pull-down menu 621 for comparison item setting (step S305). From among minor categories read out and stored in the minor category storing array variable by the comparison item display and setting unit 270 at the step S125 in FIG. 4, minor categories contained in the major category selected by the operator at the step S305 in FIG. 8 are read out (step S310). If there aren't pertinent minor categories at step S315, the processing proceeds to step S330. If there are pertinent minor categories, the minor categories read out are set as choices in the minor category setting pull-down menu 622 (step S320). If the operator selects a minor category by using the minor category setting pull-down menu 622 (step S325), item names contained in the major category and the minor category set at the step S310 and the step S320 in FIG. 8 are extracted from the item names read out and stored in the item name storing array variable at the step S125 in FIG. 4 (step S330). The extracted item names are set in choices in the item name setting pull-down menu 623 (step S335). If the operator selects an item name by using the item name setting pull-down menu 623 (step S340), the comparison item display and setting unit 270 reads out a value type of the corresponding item in the item definition table 410 from the value type field 416, and determines whether the item is qualitative data or quantitative data (step S345). If the item is quantitative data, “average” is set in the evaluation value setting pull-down menu 624 (step S355), and the processing proceeds to step S365. In this case, the evaluation value is fixed only to the “average,” and it becomes impossible to select other evaluation values. If the item is qualitative data at the step S345, values that can be assumed by the pertinent item name in the item definition table 410 are read from the value field 417, and set as choices in the evaluation value setting pull-down menu 624 (step S350). The operator selects an evaluation value in the evaluation value setting pull-down menu 624 (step S360), and then sets a display order by using the display order setting pull-down menu 625 (step S365). As choices in the display order setting pull-down menu 625, two kinds, i.e., “descending” and “ascending” are previously set.

Subsequently, the grouping item display and setting unit 260 executes processing at step S135 in FIG. 4. At the step S135, rules containing items set by the operator at the step S130 in the consequent are extracted from among the rules extracted at the step S120, and stored in rule storing variables. The rule storing variables are array variables having a structure similar to that of the association rule definition table shown in FIG. 3. In addition, data items contained in the antecedent of the rules stored in the variables are taken out, and major categories of those items are set as choices in the major category setting pull-down menu 631 for grouping item setting (step S140).

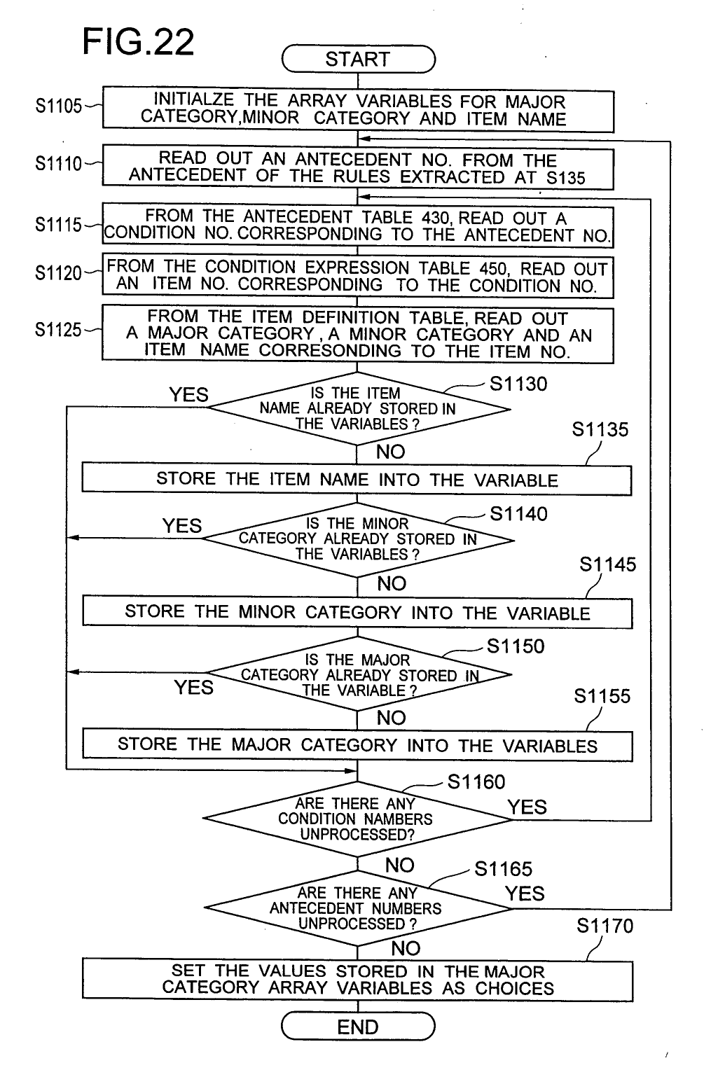

Concrete processing conducted at the step S140 will now be described with reference to FIG. 22. First, major category storing array variables, minor category storing array variables, and item name storing array variables for grouping item setting are prepared and initialized (step S1105). Subsequently, one of a plurality of antecedent nos. contained in the antecedent of the rules extracted at the step S135 is read out from the rule storing variable (step S1110). For example, if a rule of a rule no. 1 shown in the association rule definition table shown in FIG. 3 is already stored in the rule storing variable, an antecedent no. 1 is read out at the step S1110. With reference to the antecedent table 430, one of condition nos. corresponding to the antecedent no. read out is read out (step S1115). Thereafter, with reference to the condition expression table 450, an item no. corresponding to the condition no. read out is read out (step S1120). With reference to the antecedent table 430 in the case of the above-described example, two condition nos. 1 and 5 are already stored as condition nos. corresponding to the antecedent no. 1. At the step S1115, 1 is first read out as the condition no. At the step S1120, an item no. 19 corresponding to the condition no. 1 in the condition expression table 450 is read out. In addition, with reference to the item definition table 410, a major category, a minor category and an item name corresponding to the item no. read out are read out (step S1125). In the above-described example, the item no. 19 is read out at the step S1120. At the step S1125, therefore, “basic information” and “gender” are read out from a field corresponding to the item no. 19 in the item definition table 410 as the major category and the item name. In this example, the minor category does not exist.

It is determined whether the item name read out is already stored in the item name storing array variables. If the item name is already stored, the processing proceeds to step S1160 (step S1130). Otherwise, the item name read out is newly stored in the item name storing array variable (step S1135). Subsequently, it is determined whether the minor category read out is already stored in the minor category storing array variables. If the minor category is already stored, the processing proceeds to the step S1160 (step S1140). Otherwise, the minor category read out is newly stored in the minor category storing array variable (step S1145). In addition, it is determined whether the major category read out is already stored in the major category storing array variables. If the major category is already stored, the processing proceeds to the step S1160 (step S1150). Otherwise, the major category read out is newly stored in the major category storing array variable (step S1155). It is determined whether there are unprocessed consequent nos. If there are unprocessed consequent nos., the processing at the step S1015 and the subsequent steps are repeated with respect to those condition nos. (step S1160). If there aren't unprocessed consequent nos., it is determined whether there are unprocessed antecedent nos. If there are unprocessed antecedent nos., the processing at the step S1110 and the subsequent steps is repeated with respect to the unprocessed antecedent nos. (S1165). Finally, major categories thus stored in the major category storing variables are set as choices in the major category setting pull-down menu 631 for grouping item setting in the analysis screen (S1170). Thus, the processing shown in FIG. 22 is finished. Subsequently, processing at step S145 shown in FIG. 4 is executed.

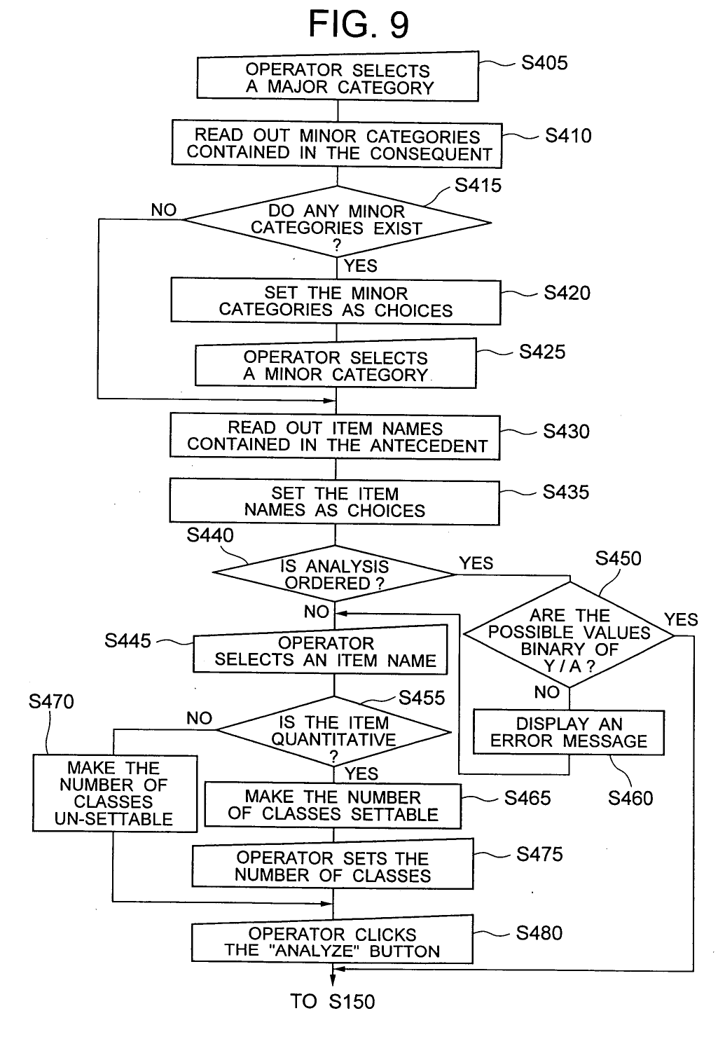

At the step S145, details of the grouping item are specified by using the grouping item setting area 630 in the analysis screen 600. A detailed flow of operation conducted by the operator at the step S145 and a screen control method is shown in FIG. 9. Control of the screen is conducted by the grouping item display and setting unit 260. First, the operator selects a major category of an item to set, from choices in the major category setting pull-down menu 631 for grouping item setting (step S405). From among minor categories read out and stored in the minor category storing array variable by the grouping item display and setting unit 260 at the step S140 in FIG. 4, minor categories contained in the major category selected by the operator at the step S405 in FIG. 9 are read out (step S410). If there aren't pertinent minor categories at step S415, the processing proceeds to step S430. If there are pertinent minor categories, the minor categories read out are set as choices in the minor category setting pull-down menu 632 (step S420). If the operator selects a minor category by using the minor category setting pull-down menu 632 (step S425), item names contained in the major category and the minor category set at the step S405 and the step S425 in FIG. 9 are extracted from the item names read out and stored in the item name storing array variable at the step S140 in FIG. 4 (step S430). The extracted item names are set in choices in the item name setting pull-down menu 633 (step S435).

If when a minor category is selected values that can be assumed by all items contained in the minor category are binary, “Y and N,” the analysis can be executed. At step S440, therefore, it is determined whether the operator has clicked the “analyze” button 650. If the button is clicked, values that can be assumed by all items contained in the minor category are checked at step S450. If the values that can be assumed are only binary “Y and N,” the processing proceeds to step S150. If values other than “Y and N” can be assumed, an error message to the effect that the analysis cannot be executed is displayed (step S460) and the processing proceeds to step S445.

If the operator selects an item name by using the item name setting pull-down menu 633 (step S445), the grouping item display and setting unit 260 reads out a value type of the corresponding item in the item definition table 410 from the value type field 416, and determines whether the value type is qualitative data or quantitative data (step S455). If the value type is quantitative data, it is made possible to input a numerical value to a text box 634 for setting the number of classes (step S465). The operator inputs the number of classes to the text box 634 (step S475). If the value type is qualitative data, it is made impossible to input a numerical value to the text box 634 for setting the number of classes (step S470) and then the processing proceeds to step S480. At the step S480, the operator clicks the “analyze” button and processing at the step S150 and subsequent steps is executed.

At the step S150 in FIG. 4, the search condition display and setting unit 250 extracts rules that contain the item selected at the step S145 in the antecedent from among rules extracted at the step S135, and stores the extracted rules in the rule storing array variable. If an item name is set at the step S145, rules that contain the item name in the antecedent are extracted. If only the major category or minor category is set at the step S145, rules containing some item included in a plurality of items belonging to the category are extracted. In addition, the antecedent in all extracted rules is checked. From the antecedent of the extracted rules, condition expressions containing items other than those set by the operator at the step S145 are extracted, and condition nos. are stored in the variable (step S155). If items are set at the step S145, condition expressions containing items other than those items are extracted. If only the major category or minor category is set at the step S145, condition expressions containing items that do not belong to the category are extracted. At step S160, the search condition display and setting unit 250 checks the flag field 515 in the condition storing variable 510 as regards the condition expressions extracted at the step S155, and extracts the condition for which patient data does not exist (condition for which the value in the flag field 515 is 0) and the condition that does not correspond with the patient data (condition for which the value in the flag field 515 is −1). Items contained in the condition for which patient data does not exist are displayed in a column of “items to check” in the search condition setting area 640 in the analysis screen 600. Items contained in the condition that does not correspond with the patient data are displayed in a column of “items to control” in the search condition setting area 640. At this time, as regards the items contained in the condition that does not correspond with the patient data, current patient data are displayed. As regards the condition that correspond with the patient information, the item name and the value of the patient data for the item may be displayed in the patient information display area 610. Owing to the display, the operator can know the condition used for the analysis besides the grouping item and the search condition.

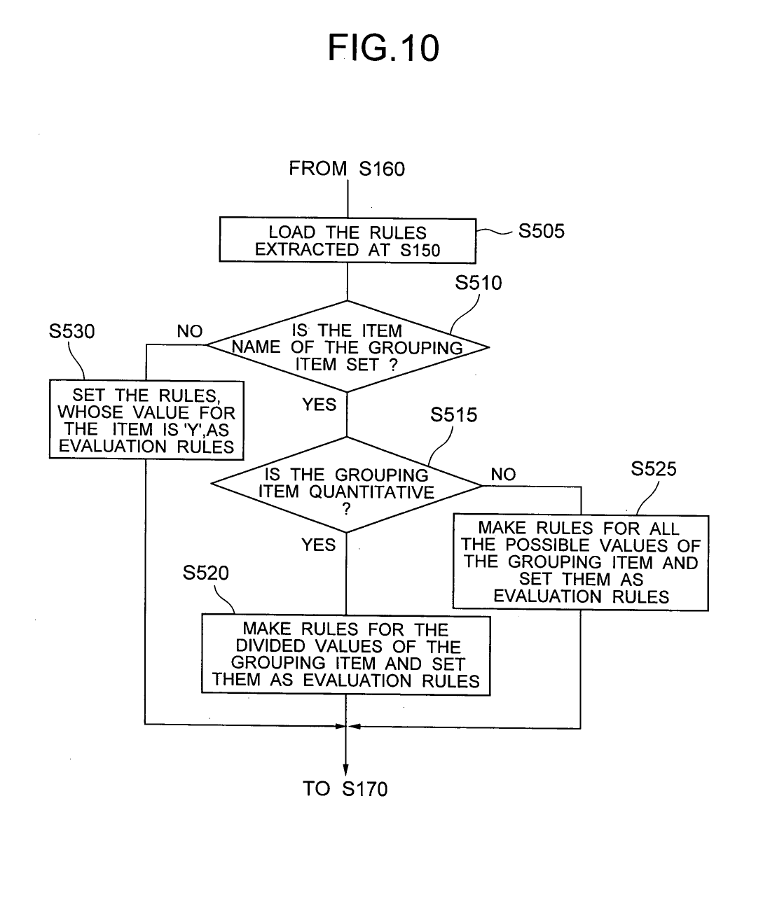

Subsequently, the processing proceeds to step S165, and the evaluation unit 140 creates evaluation rules on the basis of a plurality of rules extracted at the step S150. Details of the processing conducted at the step S165 will now be described with reference to FIG. 10. First, the rules extracted at the step S150 are loaded (step S505). It is determined whether an item name is already set in the item name setting pull-down menu 633 in the analysis screen 600 (step S510). If an item name is not set, then only a major category or minor category is set as the grouping item, and the values that can be assumed by all items contained in this category are binary, “Y” and “N.” Therefore, the item definition table 410 is checked, and items contained in the major category or minor category in the set grouping item are checked. From among rules loaded at the step S505, rules containing a condition statement that the value for these items is “Y” in the antecedent are extracted and set as evaluation rules (step S530). For example, it is supposed that a major category P and a minor category Q are set as the grouping item, three kinds of items q0, q1 and q2 are included in this minor category. In this case, rules containing a condition expression “q0=Y,” “q1=Y,” or “q2=Y” in the antecedent are extracted and set as evaluation rules.

If it is found at the step S510 that the item name of the grouping item is already set, then the value type field 416 in the item definition table 410 is referred to and it is determined whether the set item is quantitative data or qualitative data (step S515). If the item is quantitative data, then values that can be assumed by the grouping item are divided by the number set in the number of classes setting text box 634, and rules with the condition expressions for the grouping item in the antecedent of the rules loaded at the step S505 being replaced by respective division ranges are created (step S520). For example, a rule “IF item A=a, item B=b THEN item C=c” is loaded at the step S505. It is now supposed that the item A is quantitative data and A and 3 are already set in the grouping item and the number of classes, respectively. With reference to the value field 417 in the item definition table 410, a value that can be assumed by the item A is checked. If the value that can be assumed is in the range of 0 to 90, the following rules of three kinds are created and set as evaluation rules.

(1) IF item A<30, item B=b THEN item C=c

(2) IF 30≦item A<60, item B=b THEN item C=c

(3) IF 60≦item A, item B=b THEN item C=c

If the grouping item is qualitative data at the step S515, a value that can be assumed by the grouping item defined in the value field 417 in the item definition table 410 is checked. In addition, rules with the condition expressions containing the grouping item in the antecedent of the rules loaded at the step S505 being replaced by respective values that can be assumed are created (step S525). For example, a rule “IF item D=d0, item B=b THEN item C=c” is loaded at the step S505. It is now supposed that the item D is quantitative data and D is already set in the grouping item. With reference to the value field 417 in the item definition table 410, a value that can be assumed by the item D is checked. If the values that can be assumed are three kinds, d0, d1 and d2, the following rules of three kinds are created and set as evaluation rules.

(1) IF item D=d0, item B=b THEN item C=c

(2) IF item D=d1, item B=b THEN item C=c

(3) IF item D=d2, item B=b THEN item C=c

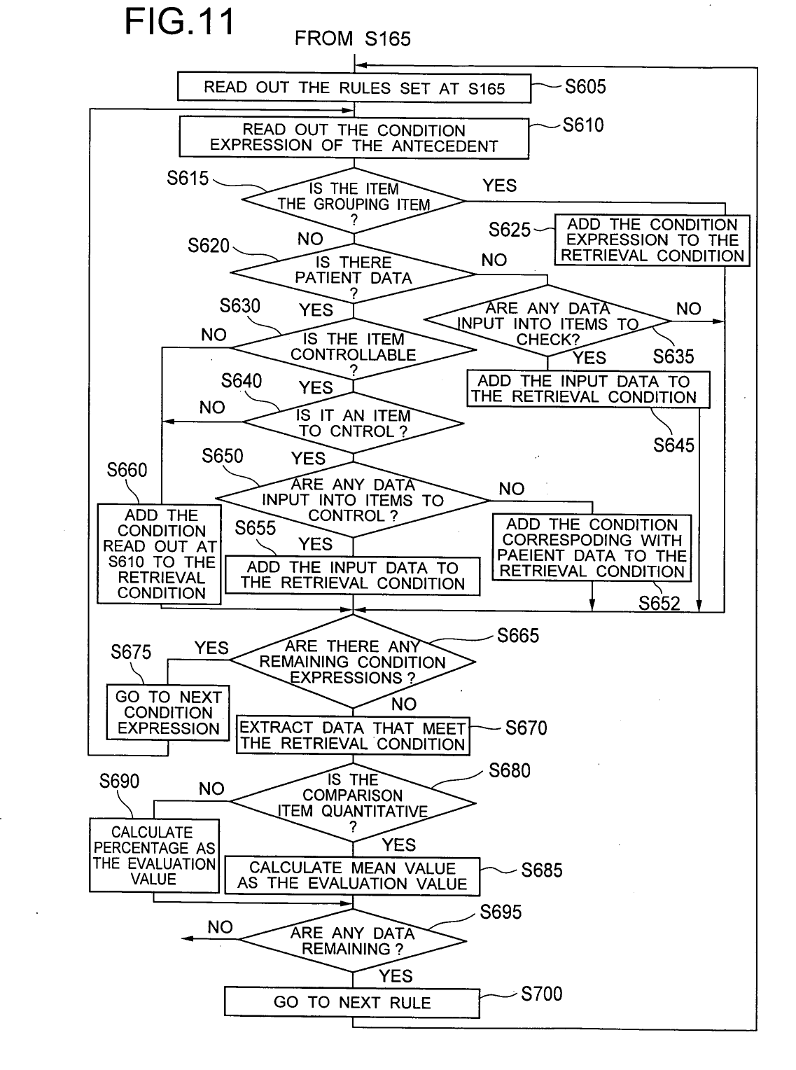

Subsequently, the processing proceeds to step S170 shown in FIG. 4. As regards a plurality of evaluation rules set at the step S165, the evaluation unit 140 calculates evaluation values. Details of the processing conducted at the step S170 will now be described with reference to FIG. 11. First, one rule is read out from among a plurality of rules set for evaluation at the step S165 (step S605). Thereafter, one condition expression included in a plurality of condition expressions that constitute the antecedent of the rule read out is read out (step S610). Subsequently, it is determined whether an item name included in the condition expression corresponds with the item name set in the grouping item setting area 630 in the analysis screen 600 by the operator (step S615). If there are item names set using the item name setting pull-down menu 633, it is determined whether the item name contained in the condition expression corresponds with the item names. If there are no set items, item names contained in categories that are set in the major category setting pull-down menu 631 and the minor category setting pull-down menu 632 are checked using the item definition table 410. It is determined whether the item name included in the condition expression corresponds with any of the item names. In the case of correspondence, the condition expression read out at the step S610 is added to the retrieval condition for evaluation as it is (step S625). In the case of noncorrespondence, it is determined whether there is patient data with respect to the item name contained in the condition expression (step S620). If there is patient data, it is further determined whether the item is a controllable item (step S630). If the item is not a controllable item, the condition expression read out at the step S610 is added to the retrieval condition for evaluation calculation as it is (step S660). If it is found at the step S630 that the item is a controllable item, it is determined whether the item is already set as an item to control (step S640). If the item is not set as an item to control, the condition is added to the retrieval condition as it is (step S660). If the item is set as an item to control, it is determined whether the operator inputs a value for this item in the “items to control” in the search condition setting area 640 in the analysis screen 600 (step S650). If there is input, a condition expression satisfying the input contents of the operator is created and added to the retrieval condition (step S655). If there isn't input, a condition expression that corresponds with the patient data with respect to this item is created and added to the retrieval condition (step S652). If there aren't patient data at the step S620, the operator can input a value as “items to check” in the search condition setting area 640 in the analysis screen 600. It is determined whether the operator has input a value with respect to this item (step S635). If the operator has input a value, a condition expression satisfying the contents input by the operator is created and added to the retrieval condition (step S645). If the operator has not input a value, the condition is not used for the retrieval and the processing proceeds to step S665.

At the step S665, it is determined whether processing ranging from the step S610 to the step S660 has been executed with respect to all condition expressions included in the antecedent of the rules read out at the step S605. If there are remaining condition expressions, the next condition expression is read out and the processing at the step S610 and subsequent steps is conducted (step S675). If the processing is finished for all condition expressions that constitute the antecedent, data that correspond with the created retrieval condition are extracted from the clinical information database 120 (step S670). Subsequently, it is determined whether the comparison item set in the comparison item setting area 620 in the analysis screen 600 is quantitative data or qualitative data (step S680). If the comparison item is qualitative, the component ratio of the comparison item in the extracted data is checked (step S690). “The component ratio of the comparison item” means a ratio of each of values that can be assumed by the comparison item to extracted data. After the processing at the step S685 or S690, it is determined whether the processing at the step S605 and the subsequent steps has been conducted on all rules set at the step S165 (step S695). If there are remaining rules, the processing at the step S605 and the subsequent steps is conducted on the next rule (step S700). If the processing is finished on all rules, the processing proceeds to step S175 shown in FIG. 4.

At the step S175 shown in FIG. 4, the analysis result display 150 determines whether the operator has input a value to the search condition setting area 640 in the analysis screen 600. If there is no value input, a first display screen is displayed (step S180). If there is an input value, a second display screen is displayed (step S185).

In the first display screen, an evaluation value calculated at the step S170 on a plurality of evaluation rules set at the step S165 is displayed in the analysis result display area 660. If the comparison item is quantitative data, the average becomes an evaluation value. In this case, evaluation values are sorted and displayed according to the display order (descending or ascending) set in the display order setting pull-down menu 625 by the operator. Furthermore, if the comparison item is qualitative data, the component ratio of the value that can be assumed by the item becomes the evaluation value. In this case, the operator selects one value from among values that can be assumed by the comparison item as a value used for sorting of display order, by using the evaluation value setting pull-down menu 624. The component ratio of the selected value is displayed according to the display order (descending or ascending) set in the display order setting pull-down menu 625.

The evaluation value is displayed by, for example, a bar (bar graph). As compared with the display of the numerical values themselves, it is possible to grasp the difference in evaluation value among groups owing to the bar display. If an item name is specified in the grouping item setting area 630, the value on the right side of the condition expression for the specified item name in the antecedent of the evaluation rule corresponding to each evaluation value is displayed on the left side of the bar. If an item name is not set in the grouping item setting area 630 (only the major category or the minor category is set), an item name contained in the set category in the antecedent of the corresponding evaluation rule is displayed on the left side of the bar.

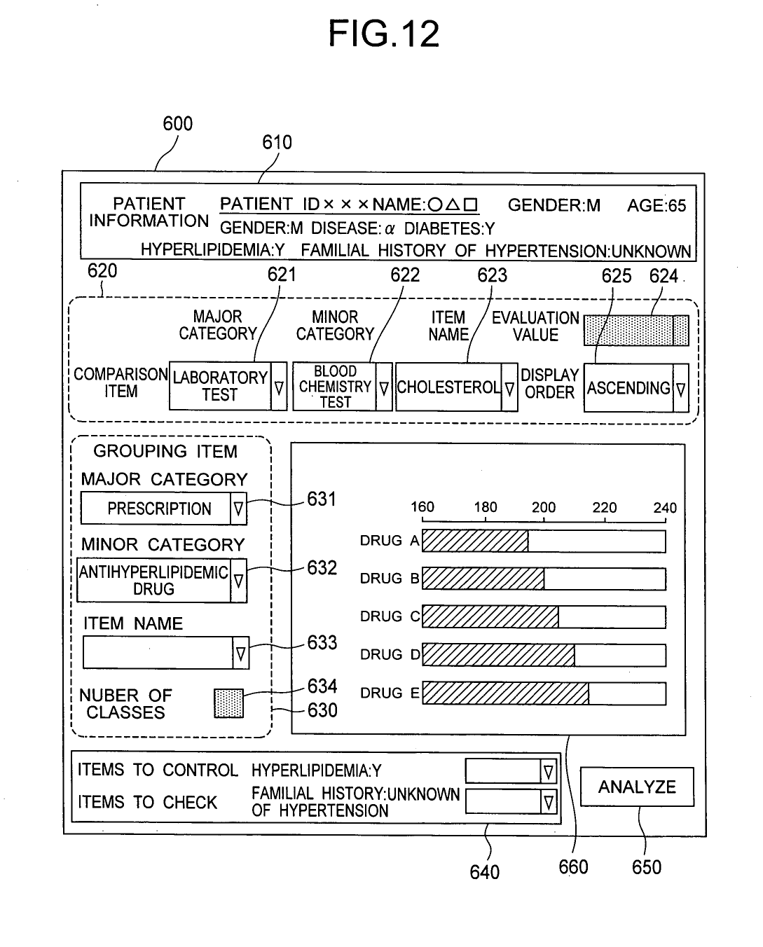

Screen examples of the first display screen are shown in FIGS. 12, 13 and 14. In FIG. 12, “cholesterol” which is quantitative data is set in the comparison item, and “ascending” is set in the display order. Furthermore, as for the grouping item, “prescription” is set in the major category and “anti-hyperlipidemic drug” is set in the minor category. The item name is not set. In this example, the evaluation rules set at the step S165 include in the antecedent item names (here, drugs A to E) contained in the “anti-hyperlipidemic drug” set in the minor category. Averages of the comparison item (here, cholesterol value) are displayed in the analysis result display area 660 using bars in the ascending order at this time. Furthermore, item names (drugs A to E) contained in the major category and the minor category set in the grouping item are displayed by the side of the bars. It is meant that the evaluation value indicated by each bar includes the item name displayed on the left side in the antecedent.

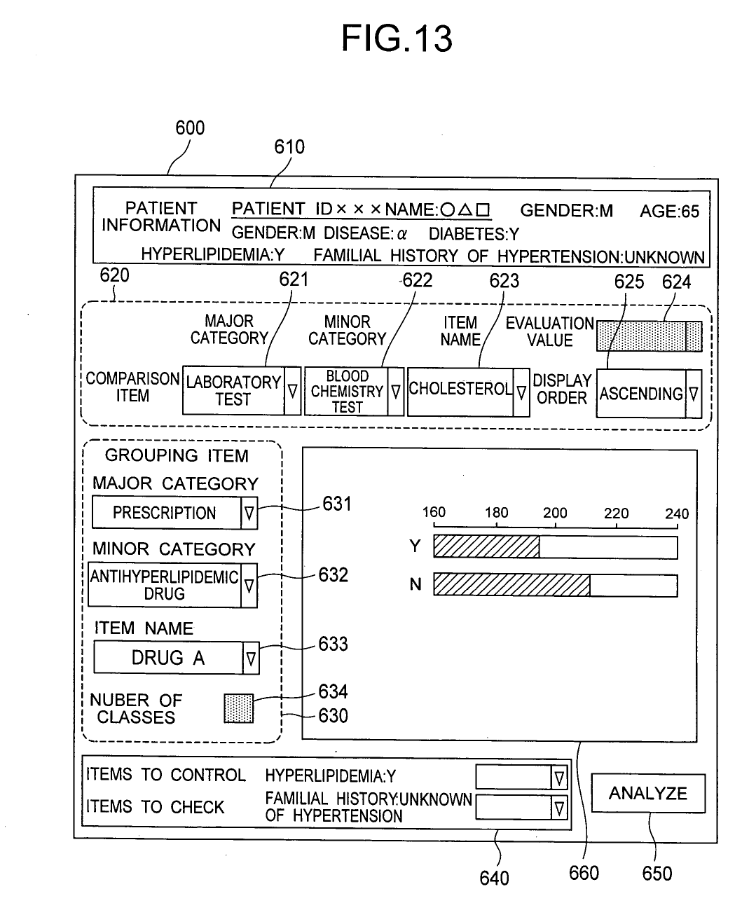

In FIG. 13, the setting of the comparison item is the same as that in FIG. 12. As the grouping item, “drug A” is set as the item name, besides the major category and the minor category. In this example, the evaluation rules set at the step S165 are a rule containing “drug A=Y” in the antecedent and a rule containing “drug A=N” in the antecedent. “Y” is displayed on the left side of a bar that indicates an evaluation value for the former rule. “N” is displayed on the left side of a bar that indicates an evaluation value for the latter rule.

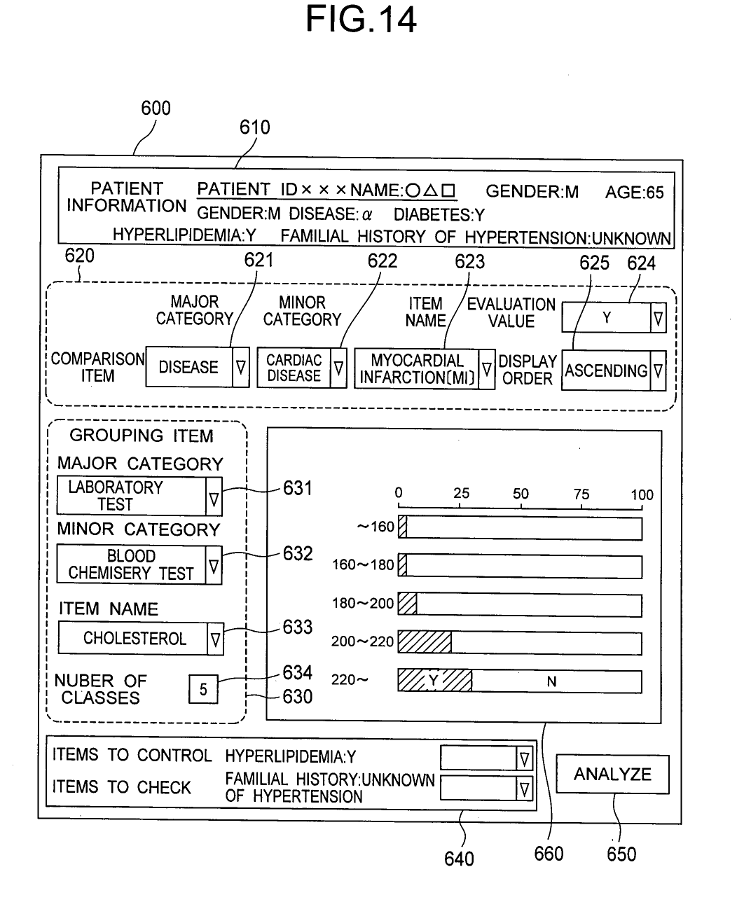

In an example shown in FIG. 14, “myocardial infarction [MI]” which is qualitative data is set in the comparison item, and “cholesterol” which is quantitative data is set in the grouping item. “5” is set in the number of classes setting text box in the grouping item setting area 630. Therefore, each of the evaluation rules set at the step S165 contains a condition expression that specifies one of ranges obtained by classifying possible cholesterol values into five ranges, in the antecedent. In this example, the cholesterol value is classified into five ranges, “less than 160,” “at least 160 and less than 180,” “at least 180 and less than 200,” “at least 200 and less than 220,” and “at least 220.” In this case, rules respectively containing condition expressions “cholesterol<160,” “160≦cholesterol<180,” “180≦cholesterol<200,” “200≦cholesterol<220” and “220≦cholesterol” in the antecedent are set as the evaluation rules. On the left side of a bar representing an evaluation value, a cholesterol condition contained in a rule corresponding to the evaluation value is displayed as a numerical value range. In this example, a value that can be assumed by “myocardial infarction [MI],” set in the evaluation value is binary, “Y” or “N.” Since “Y” is already set in the evaluation value setting pull-down menu 624 and “ascending” is already set in the display order setting pull-down menu 625, evaluation values are sorted in the order of the increasing component ratio of “Y” (ascending) and displayed.

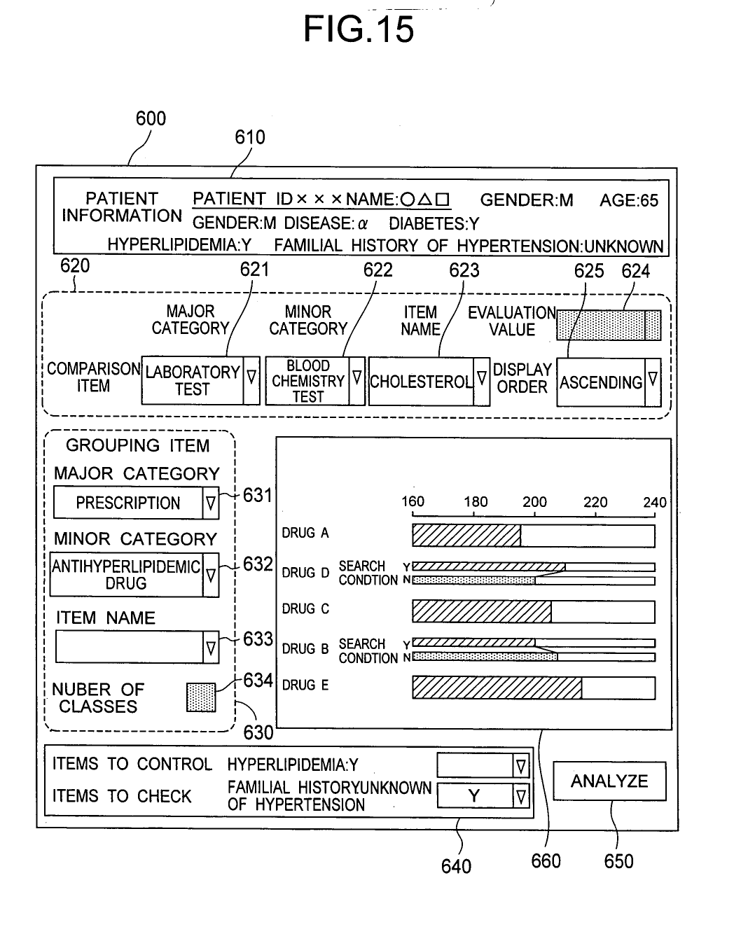

Basically, processing of the second display conducted at the step S185 shown in FIG. 4 is also the same as the first display processing. For rules in which the evaluation value has changed, an evaluation value obtained when the search condition is not set and an evaluation value obtained when the search condition is set are displayed in two lines, unlike the first display processing in which conditions are not set in the search condition setting area 640. In an example shown in FIG. 15, the comparison item and the grouping item are the same as those shown in FIG. 12. In “familial history of hypertension” for “the items to check” in the search condition setting area 640, however, “Y” is already set. In this example, evaluation values for the rule containing “drug D=Y” in the antecedent and the rule containing “drug B=Y” in the antecedent have changed, unlike the example shown in FIG. 12 in which the search condition is not set. As evaluation values corresponding to each of the drug B and the drug D, a bar indicating an evaluation value obtained when the search condition is not set and a bar indicating an evaluation value obtained when the search condition is set are displayed in two lines. Furthermore, since the evaluation values have changed, the display order of evaluation values is also different from that shown in FIG. 12.

After the first display and the second display are conducted, the operator further sets various search conditions and analysis is executed (step S190). As a result, analysis results in the case where various kinds of information is added or altered can be obtained.

As heretofore described, according to the clinical data analysis system according to the present invention, a storage unit (the association rule database 130) describing association (association rules) between clinical information is provided, and the comparison item display and setting unit 270 presents items to compare on the basis of contents stored in the storage unit (the steps S125 and S130). As a result, it becomes possible to present only items that have a possibility of being changed by other clinical information, as items to compare. By narrowing down a large number of data items to only items that have a possibility to change and presenting only those items, an effect that the operator can set items to compare, rapidly and precisely is obtained.

Furthermore, the grouping item display and setting unit 260 extracts association containing an item name set by the comparison item display and setting unit 270, from the storage unit (the association rule database 130) describing the association (association rules) between clinical information. On the basis of the extracted association, the grouping item display and setting unit 260 presents items to use in conditions for division into a plurality of groups (the steps S135, S140 and S145). As a result, it becomes possible to present only items that have a possibility of giving a change to the comparison item set by the comparison item display and setting unit 270 as choices of the conditions for division into a plurality of groups. By narrowing down a large number of data items to only items that have a possibility of giving a change to the comparison item and presenting only those items, an effect that the operator can set the grouping condition rapidly and precisely is obtained.

Furthermore, the search condition display and setting unit 250 presents items to use for the condition setting to extract data, on the basis of the association (association rules) between clinical information extracted by the grouping item display and setting unit 260 (the steps S150, S155, S160 and S190). As a result, it is possible to present only items that have a possibility of giving a change to the comparison item set by the comparison item display and setting unit 270, as candidates for search condition setting. By narrowing down a large number of data items to only items that have a possibility of giving a change to the comparison item and presenting only those items, an effect that the operator can set the search condition rapidly and precisely is obtained.

Furthermore, the evaluation unit 140 sets evaluation rules by using information stored in the clinical information database 120 on the basis of contents set as the comparison item, the grouping item and the search condition (the step S165), and calculates evaluation values (the step S170). As a result, it becomes possible to compare evaluation value changes with respect to various kinds of condition setting. As to influences of a change in a certain data item in clinical information exerted upon other items, the operator can conduct analysis and simulation by using actual data, resulting in an effect. Furthermore, if an evaluation value has changed by setting a search condition, an evaluation value obtained when the search condition is not set and an evaluation value obtained when the search condition is set are displayed in two lines (step S185). As a result, an effect that the operator can grasp the evaluation value change more easily is obtained.

Furthermore, the association rule retrieval unit 210 retrieves association (association rules) between clinical information that have a possibility of being true of a specific patient (step S120). As to the specific patient, therefore, only a first item that has a possibility of being changed by therapy or the like and a second item that has a possibility of giving a change to the first item can be presented as choices for analysis condition setting. This results in an effect that an analysis result that is effective in diagnostic decision of the specific patient can be obtained rapidly and precisely.

The present embodiment has been described with reference to the configuration shown in FIG. 1. However, the present embodiment is not restricted to this configuration. For example, all of the processing heretofore described can also be executed as computer programs.

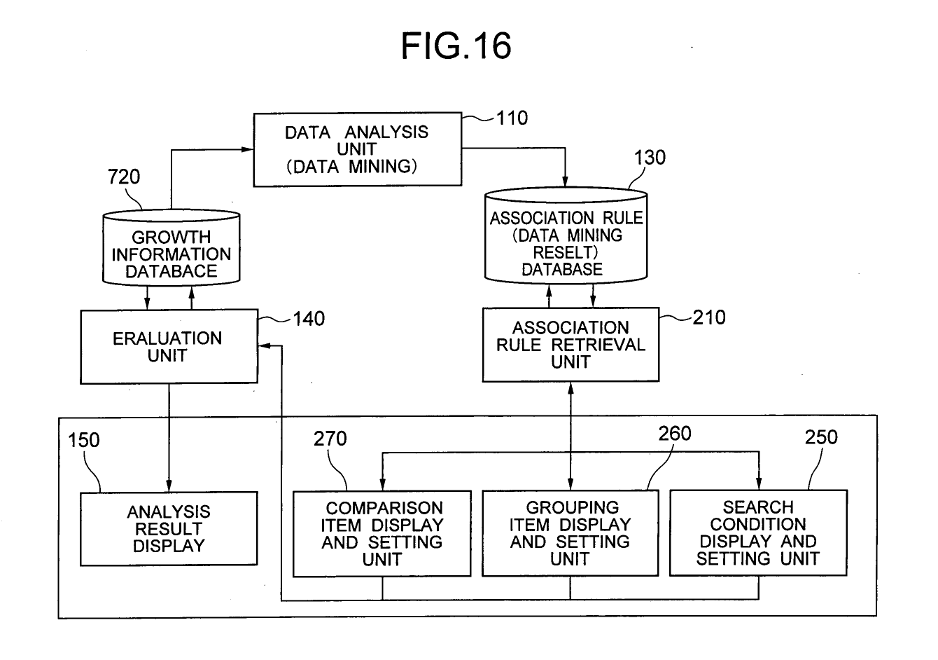

A configuration example of a plant growth data analysis system according to the present invention is shown in FIG. 16. The present configuration is basically the same as the configuration of the clinical data analysis system shown in FIG. 1. However, the clinical information database 120 in FIG. 1 is replaced by a growth information database 720. In addition, counterparts of the clinical information retrieval unit 220, the rule temporary storage 230, the patient selection unit 240 and the clinical information temporary storage unit 280 in FIG. 1 are removed. Information concerning growth of various plants cultivated under various conditions is already stored in the growth information database 720. In the same way as the first embodiment shown in FIG. 1, association rules obtained by applying the association rule mining to the contents of the growth information database 720 are previously stored in the association rule database 130. Or a rule input unit may be provided separately for the association rule database in order to allow the operator to directly input association rules.

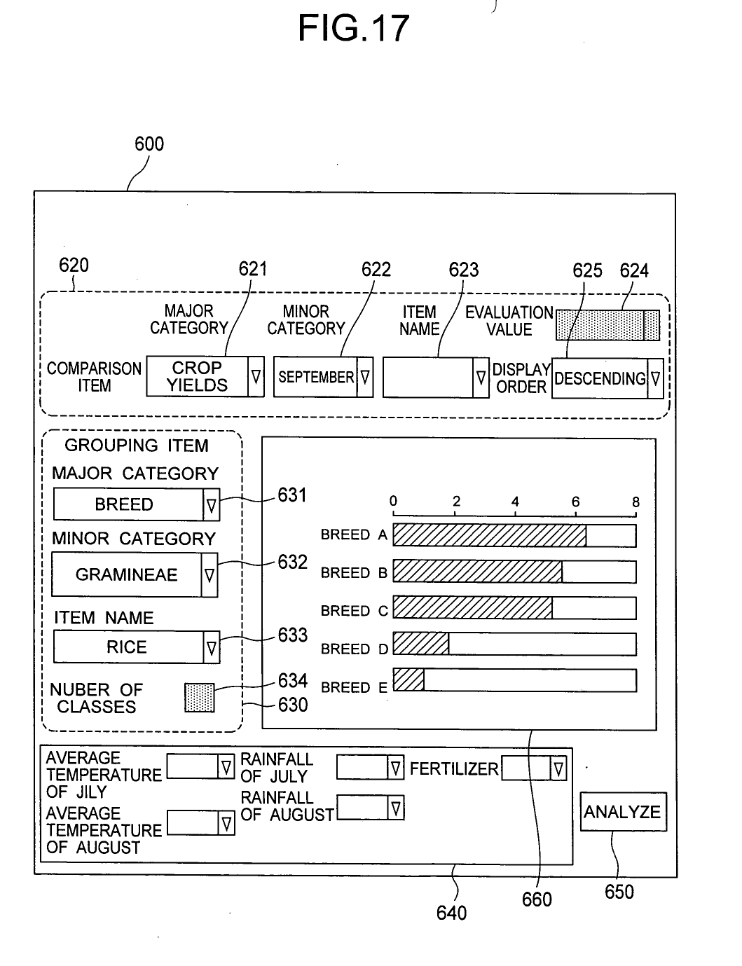

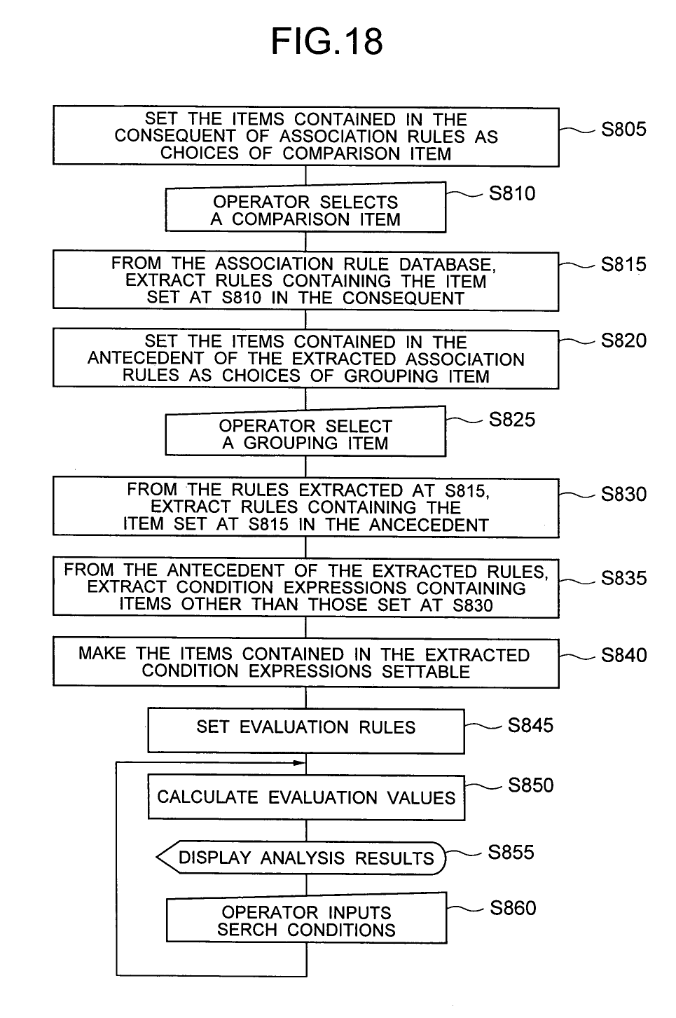

An analysis screen example in the present embodiment is shown in FIG. 17. The patient information display area 610 is removed from the analysis screen example in the first embodiment shown in FIG. 7. In the first embodiment, items for search condition setting are classified into two kinds: “items to control” and “items to check” and displayed in the search condition setting area. In the present embodiment, however, the items for search condition setting are displayed without being classified. An analysis processing flow based on the present configuration will now be described with reference to FIG. 18.

First, the comparison item display and setting unit 270 retrieves items contained in the consequent in all rules in the association rule database by using the association rule retrieval unit, and sets the obtained items as choices in the major category setting pull-down menu 621, the minor category setting pull-down menu 622 and the item name setting pull-down menu 623 for comparison item setting in the analysis screen 600 shown in FIG. 17 (step S805). If the operator sets a comparison item by using the comparison item setting area 620 in the analysis screen 600 (step S810), the association rule retrieval unit 210 extracts rules containing the item thus set in the consequent, from the association rule database 130 (step S815). By the way, operations of the evaluation value setting pull-down menu 624 and the display order setting pull-down menu 625 are the same as those in the first embodiment.

Subsequently, the grouping item display and setting unit 260 sets items contained in condition expressions in the antecedent of the extracted rules as choices in the major category setting pull-down menu 631, the minor category setting pull-down menu 632 and the item name setting pull-down menu 633 in the analysis screen 600 (step S820). If the operator sets a grouping item (step S825), the association rule retrieval unit 210 further extracts rules containing the item set by the operator at the step S825 in the antecedent, from the rules extracted at the step S815 (step S830). The search condition display and setting unit 250 extracts items other than items set at the step S830, from condition expressions contained in the antecedent of these rules (step S835), and displays pull-down menus for setting conditions of those items in the search condition setting area 640 in the analysis screen 600 (step S840). At step S845, the evaluation unit 140 creates evaluation rules by using the rules extracted at the step S830 and the grouping item set by the operator. This processing is the same as that conducted at the step S165 in the first embodiment.

At the next step S850, the evaluation unit 140 calculates evaluation values for the evaluation rules set at the step S845. When calculating evaluation values, a condition statement for search is first created for each of the evaluation rules. As for condition statements, the antecedent of each rule is checked, and condition expressions containing the item set in the grouping item are used as they are. As for other condition expressions, if a condition is previously set in the search condition setting area 640 for an item contained in the condition statement, the condition is added to the search condition statement. If the condition is not previously set in the search condition setting area 640, the condition expression is not used in the search condition statement. By using the search condition statement thus created, pertinent data in the growth information database 720 is extracted and the evaluation values are calculated. Calculation of the evaluation values is conducted in the same way as the first embodiment. The analysis result display 150 displays the evaluation values thus calculated in the analysis result display area 660 in the analysis screen 600 (step S855). Thereafter, each time the operator inputs or alters a search condition and clicks the “analyze” button 650, analysis is conducted and results are displayed (step S860).

As heretofore described, according to the growth data analysis system according to the present invention, a storage unit (the association rule database 130) describing association (association rules) between growth data is provided, and the comparison item display and setting unit 270 presents items to compare on the basis of contents stored in the storage unit (the steps S805 and S810) As a result, it becomes possible to present only items that have a possibility of being changed by other data items, as items to compare. By narrowing down a large number of data items to only items that have a possibility to change and presenting only those items, an effect that the operator can set items to compare, rapidly and precisely is obtained.

Furthermore, the grouping item display and setting unit 260 extracts association containing an item name set by the comparison item display and setting unit 270, from the storage unit (the association rule database 130) describing the association (association rules) between growth data (step S815). On the basis of the extracted association, the grouping item display and setting unit 260 presents items to use in conditions for division into a plurality of groups (the steps S820 and S825). As a result, it becomes possible to present only items that have a possibility of giving a change to the comparison item set by the comparison item display and setting unit 270 as choices of the conditions for division into a plurality of groups. By narrowing down a large number of data items to only items that have a possibility of giving a change to the comparison item and presenting only those items, an effect that the operator can set the grouping condition rapidly and precisely is obtained.

Furthermore, the search condition display and setting unit 250 presents items to use for the condition setting to extract data, on the basis of the association (association rules) between growth data extracted by the grouping item display and setting unit 260 (the steps S830, S835, S840 and S860). As a result, it is possible to present only items that have a possibility of giving a change to the comparison item set by the comparison item display and setting unit 270, as candidates for search condition setting. By narrowing down a large number of data items to only items that have a possibility of giving a change to the comparison item and presenting only those items, an effect that the operator can set the search condition rapidly and precisely is obtained.

Furthermore, the evaluation unit 140 sets evaluation rules by using information stored in the growth data database 120 on the basis of contents set as the comparison item, the grouping item and the search condition (the step S845), and calculates evaluation values (the step S850). As a result, it becomes possible to compare evaluation value changes with respect to various kinds of condition setting. As to influences of a change in a certain item in growth data exerted upon other items, the operator can conduct analysis and simulation by using actual data, resulting in an effect.

The present embodiment has been described with reference to the configuration shown in FIG. 16. However, the present embodiment is not restricted to this configuration. For example, all of the processing heretofore described can also be executed as computer programs.

The present invention can be used for various systems for finding association between data. As described with reference to the embodiments, the present invention is suitable for application to a system that extracts and presents information required for coming decision, from data obtained under various past conditions, such as clinical data or growth data. The present invention can be applied to various data analysis systems as well, besides the systems described with reference to the embodiments.

It should be further understood by those skilled in the art that although the foregoing description has been made on embodiments of the invention, the invention is not limited thereto and various changes and modifications may be made without departing from the spirit of the invention and the scope of the appended claims.

1. A data analysis system comprising:
a first storage for storing information;
a second storage for storing association data, the association data describing association between items contained in information stored in said first storage, the association data comprising antecedent data and consequent data;
a first setting unit for retrieving the consequent data in the association data and causing a first item to be set from among items contained in the consequent data;
a second setting unit for retrieving the antecedent data in the association data having the first item in the consequent data from the association data and causing a second item for dividing the information into a plurality of groups to be set;
an evaluation unit for retrieving information containing the first item and the second item from said first storage and calculating an evaluation value for each of groups obtained by the division using the second item; and
a display for displaying the evaluation value calculated by said evaluation unit for each of groups.

2. A data analysis system according to claim 1, wherein said first storage has at least kind of information concerning major category, minor category, controllability, whether data is qualitative data or quantitative data, and possible values, with respect to an item contained in the antecedent data and an item contained in the consequent data.

3. A data analysis system according to claim 1, wherein said evaluation unit calculates a component ratio of information contained in each group.

4. A data analysis system according to claim 1, comprising:
a selection unit for conducting selection on information stored in said first storage;
an association data retrieval unit for retrieving association data relating to the information selected by said selection unit, from said second storage; and
a third storage for storing association data retrieved by said association data retrieval unit.

5. A data analysis system according to claim 4, comprising a third setting unit for retrieving the antecedent data that does not have the second item from the antecedent data in the retrieved association data, extracting a third item group, and causing a condition to be set in the third item group.

6. A data analysis system according to claim 5, wherein
said association data retrieval unit classifies items contained in the antecedent, relative to the information selected by said selection unit, into items that correspond with the information, items for which there is no information, items that do not correspond with the information and that are controllable, and items that do not correspond with the information and that are uncontrollable, and excludes the association data containing the items that do not correspond with the information and that are uncontrollable in the antecedent, and
said third setting unit causes a condition to be set with respect to the items for which there is no information, and items that do not correspond with the information and that are controllable.

7. A data analysis system according to claim 6, wherein
said evaluation unit calculates the evaluation value for each of groups, as regards the information satisfying the condition for the third item group set by the third setting unit, and
said display displays the calculated evaluation value for each of groups.

8. A data analysis method comprising the steps of:
causing first information to be selected from a first storage which stores information;
causing an association data retrieval unit to retrieve association data relating to the first information from a second storage, the second storage storing association data, the association data describing association between items contained in information stored in the first storage, the association data comprising antecedent data and consequent data;
storing the association data retrieved by the association data retrieval unit in the third storage unit;
causing a first setting unit to retrieve the consequent data from the third storage and to cause a first item to be set;
causing a second setting unit to retrieve the antecedent data in the association data having the first item in the consequent data from the third storage, and to cause a second item for comparing a plurality of groups of information to be set;
causing an evaluation unit to retrieve information containing the first item and the second item from the first storage and calculate an evaluation value for each of groups obtained by the division using the second item; and
causing a display to display the evaluation value calculated by the evaluation unit for each of groups.

9. A data analysis method according to claim 8, wherein at said evaluation value calculation step, a component ratio of information contained in each group is calculated.

10. A data analysis method according to claim 8, comprising the step of causing a third setting unit to retrieve the antecedent data that does not have the second item from the third storage, extract a third item group, and cause a condition to be set in the third item group.

11. A data analysis method according to claim 10, comprising the step of causing the association data retrieval unit to classify items contained in the antecedent, relative to the selected information, into items that correspond with the information, items for which there is no information, items that do not correspond with the information and that are controllable, and items that do not correspond with the information and that are uncontrollable, and exclude the association data containing the items that do not correspond with the information and that are uncontrollable in the antecedent.

12. A data analysis method according to claim 10, comprising the step of causing the evaluation unit to calculate the evaluation value for each of groups, as regards the information satisfying the condition for the third item group set by the third setting unit, and causing the display to display the calculated evaluation value for each of groups.
